(19) United States
(12) Patent Application Publication
(10) Pub. No.: US 2026/0203500 A1
(43) Pub. Date: Jul. 16, 2026

(54) CONTEXT PRUNING FOR RETRIEVAL AUGMENTED GENERATION

(71) Applicant: Naver Corporation, Gyeonggi-do (KR)

(72) Inventors: Nadezhda Chirkova, Meylan (FR); Thibault Formal, Meylan (FR); Vassilina Nikoulina, Meylan (FR); Stephane Clinchant, Meylan (FR)

(73) Assignee: Naver Corporation, Gyeonggi-do (KR)

(21) Appl. No.: 19/025,600

(22) Filed: Jan. 16, 2025

(51) Int. Cl. G06F 40/284

(52) U.S. Cl. CPC G06F 40/284

(57) ABSTRACT

A context pruning system retrieves a passage initially selected and ranked by an initial passage selection model, such as a model that determines similarity based on cosine similarities between the query and various passages. The context pruning system re-ranks the passages using a re-ranking model that may also be used to prune clauses from the passages. Alternatively, the context pruning system may prune clauses from the passages using a separate clause selection model. Clauses preserved from the pruning may be used to prompt a natural language processor for a context-informed result, and the context-informed result may trigger a downstream action such as display of an interface that uses the context-informed result or operation of a robot that uses the context-informed result to physically move or audibly speak.

### FIELD

The present disclosure relates to artificial intelligence and more particularly to systems and methods for efficiently prompting a natural language processor to generate a more accurate response.

### BACKGROUND

Users and applications integrate with natural language processors such as large language models to process natural language queries. Large language models account for billions of parameters to encode the queries, generate vector embeddings of the queries that capture meanings of tokens in the queries, use the tokens to understand and enrich other tokens and meanings in a multi-layer neural network that builds an understanding of information relevant to the query and processes that information in deeper layers to perform complex tasks. Large language models are computationally expensive but powerful tools.

Large language models are limited based on what information is publicly available, and sometimes limited by an abundance of irrelevant information that is publicly available. Accordingly, large language models may be prompted with additional information and instructions that steer the large language models to generate more acceptable and better informed results. Determining what additional information and instructions to provide to a large language model for a given query can be computationally expensive and/or require human input or custom-coded human expertise based on a given use case.

High-volume and low-latency processes may not be compatible with computationally expensive and/or human-in-the-loop techniques, and such processes often fail to provide meaningful results due to the large language model's lack of the specific specialized knowledge requested by the query.

### BRIEF SUMMARY

In various embodiments, a context pruning system retrieves a passage initially selected and ranked by an initial passage selection model, such as a model that determines similarity based on cosine similarities between the query and various passages. The context pruning system re-ranks the passages using a re-ranking model that may also be used to prune clauses from the passages. Alternatively, the context pruning system may prune clauses from the passages using a separate clause selection model. Clauses preserved from the pruning may be used to prompt a natural language processor for a context-informed result, and the context-informed result may trigger a downstream action such as display of an interface that uses the context-informed result or operation of a robot that uses the context-informed result to physically move or audibly speak.

In one embodiment, a computer-implemented method includes accessing a query, and determining, from a corpus of content comprising a plurality of clauses from a plurality of passages, one or more passages that are potentially relevant to the query, wherein the one or more passages include a subset of three or more clauses. The computer-implemented method further includes encoding the subset of three or more clauses to determine a clause-to-query relevance score for each clause. A particular clause-to-query relevance score of at least one clause of the subset of three or more clauses may be dependent on content of at least one other clause of the subset of three or more clauses. The computer-implemented method further includes, based at least in part on one or more clause-to-query relevance scores of one or more clauses of the subset of three or more clauses, removing the one or more clauses from the subset of three or more clauses to generate a revised subset of clauses. The computer-implemented method further includes generating a prompt to a natural language processor. The prompt comprises instructions based at least in part on the query, and at least part of the revised subset of clauses as context for generating a response by the natural language processor. The computer-implemented method further includes prompting the natural language processor with the prompt, and accessing and storing a result generated based at least in part on the natural language processor executing the prompt.

In various embodiments, the natural language processor includes a large language model.

In a further embodiment, encoding the subset of three or more clauses includes, for each clause of the subset of three or more clauses: determining a token-to-query relevance score of each token in the clause based at least in part on a token-to-query similarity between a token embedding of the token and a query embedding of the query, and determining the clause-to-query relevance score of the clause based at least in part on the token-to-query relevance score of each token in the clause. The token embedding for at least one token of the at least one clause is based at least in part on content of the at least one clause and the at least one other clause of the subset of three or more clauses.

In a further embodiment, the computer-implemented method includes causing display of an option to adjust a threshold for selecting clauses for removal (i.e., for pruning), and receiving a selection of the option to adjust the threshold, resulting in an adjusted threshold. The one or more clauses are selected for removal based at least in part on the adjusted threshold.

In the same or a different further embodiment, determining, from the corpus of content, the one or more passages includes determining a passage-to-query similarity between vector embeddings of the plurality of passages and a vector embedding of the query.

In the same or a different further embodiment, the computer-implemented method further includes splitting a plurality of documents into a plurality of passages comprising consecutive sentences, and training a model to identify which passages of the plurality of passages are most relevant to respective queries to generate a trained passage selection model. Determining the one or more passages uses the trained passage selection model.

In the same or a different further embodiment, the computer-implemented method further includes training a model to identify which clauses of subsets of clauses are most relevant to respective queries to generate a trained clause selection model at least in part by: prompting a large language model with a plurality of prompts that request selection of most relevant clauses, and assigning weights to features of clauses based at least in part on results from prompting with the plurality of prompts. Encoding the subset of three or more clauses uses the trained clause selection model. In a further embodiment, the trained clause selection model is trained to select subsets of clauses that are most relevant to the respective queries relative to a total amount of information represented among each subset of the subsets of clauses for a particular passage.

In the same or a different further embodiment, determining the one or more passages is based at least in part on one or more passage-to-query similarity scores determined using an initial passage selection model. The computer-implemented method further includes adjusting the one or more passage-to-query similarity scores using another passage selection model, and determining the one or more clause-to-query relevance scores for the one or more clauses using a clause selection model. The clause selection model is trained to prune clauses separately from the other passage selection model that is trained to determine most relevant passages, and wherein the other passage selection model incorporates more features than the initial passage selection model.

In the same or a different further embodiment, determining the one or more passages is based at least in part on one or more passage-to-query similarity scores. The computer-implemented method further includes determining the one or more clause-to-query relevance scores for the one or more clauses and adjusting the one or more passage-to-query similarity scores using a combined machine learning model. Removing the one or more clauses from the subset of three or more clauses to generate the revised subset of clauses is based at least in part on the one or more clause-to-query relevance scores.

In the same or a different further embodiment, determining, from the corpus of content, the one or more passages results in an initial ranking of two or more passages. The computer-implemented method further includes using a single trained model to concurrently re-rank the two or more passages and select the one or more clauses for removal. In a further embodiment, the computer-implemented method further includes selecting the one or more clauses for removal based on which subsets of clauses are most relevant to the query relative to a total amount of information represented among each subset of the subsets of clauses for a particular passage.

In one embodiment, a computer-implemented method for optimizing clauses retrieved from a data store to determine an answer to a query includes retrieving from the data store a first set of clauses that are ranked by relevance to answering a query. The computer-implemented method further includes processing the query and the first set of clauses to produce a subset of clauses with a neural network that concurrently: prunes the first set of clauses to produce a subset of the first set of clauses, and generates a re-rank score for at least one passage comprising the subset of the first set of clauses by relevance to answering the query. The computer-implemented method further includes prompting a natural language processor using the query and the subset of clauses to provide context for answering the query. The neural network is trained for pruning at least some clauses using a cross-encoder that encodes queries and candidate clauses of a training set and generates output including binary masks used to prune the at least some clauses of the candidate clauses for the queries of the training set, and generated re-rank scores for passages having the candidate clauses.

In various embodiments, a system includes one or more data processors accessing one or more non-transitory computer-readable storage media storing instructions which, when executed by the one or more data processors, cause the one or more data processors to perform part or all of one or more methods disclosed herein.

In various embodiments, a computer-program product stores instructions embodied in a non-transitory machine-readable storage medium configured to cause one or more data processors to perform part or all of one or more methods disclosed herein.

The described techniques may be implemented as methods performed by a machine, as machine(s) or system(s) including memory, one or more processors, and one or more non-transitory computer-readable media storing instructions, which, when executed, cause performance of steps of the methods, and/or as one or more non-transitory computer-readable media storing processor-executable instructions which, when executed, cause one or more processors to perform steps of the methods.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIGS. 1A and 1B illustrate flow charts of example processes that efficiently and robustly prune context for retrieval augmented generation.

FIG. 2A illustrates a system diagram showing a context pruning system for training a context pruning sub-system that efficiently and robustly prune context for retrieval augmented generation.

FIG. 2B illustrates a system diagram showing a context pruning system that efficiently and robustly prunes context for retrieval augmented generation.

FIG. 3 illustrates a diagram of an example user interface showing options to adjust thresholds to use for efficiently and robustly pruning context for retrieval augmented generation.

FIG. 4 illustrates a diagram of a distributed system for efficiently and robustly pruning context for retrieval augmented generation.

FIG. 5 illustrates an example computer system that efficiently and robustly prunes context for retrieval augmented generation.

### DETAILED DESCRIPTION

A description of efficient and robust context pruning for retrieval augmented generation is provided in the following sections:
GENERATING CONTENT USING LARGE LANGUAGE MODELS AND OTHER NATURAL LANGUAGE PROCESSORS
AUGMENTING NATURAL LANGUAGE QUERIES WITH CONTEXT RELEVANT TO THE QUERIES
TRAINING A MODEL TO RE-RANK AND/OR PRUNE CONTEXT USING A CLAUSE-LEVEL ANALYSIS
PRUNING BASED ON QUERY AND CONTEXT
CONTEXT PRUNING EXAMPLES
PRUNING MULTIPLE PASSAGES
TUNING THE LEVEL OF PRUNING
EFFICIENCY AND ACCURACY GAINS FROM PRUNING BY EXTRACTION WITHOUT INCURRING AN EXTRA ROUND-TRIP OF GENERATIVE ABSTRACTION
COMPACT ARCHITECTURE FOR IDENTIFYING AND PRUNING POTENTIALLY RELEVANT CONTEXT
CONTEXT PRUNING ACROSS DOMAINS
CONCURRENTLY RANKING AND PRUNING CONTEXT
TRIGGERING DOWNSTREAM ACTIVITY AS A RESULT OF CONTEXT-INFORMED NATURAL LANGUAGE PROCESSING
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Generating Content Using Large Language Models and Other Natural Language Processors

Natural language processors include multi-layer neural networks and other machine learning implementations for consuming natural language, determining semantic meaning(s) from the natural language, and responding to the natural language with a response that is based on the semantic meaning(s). Large language models (LLMs) such as GPT-4, GPT-3.5, Llama, Gemini, Claude, and Falcon, which provide deep layers with a rich understanding of natural language across many domains and may be prompted with natural language queries that instruct the large language models to generate responses, are various examples of a natural language processor. The responses may account for any information available to the model, which is typically publicly available information accessible via the Internet, and the responses may also account for any information provided in the instructions as well as an underlying query such as a problem specification or user query and problem solving constraints specified by the instructions.

Large language models and other natural language processors may be interacted with by users or applications. Users may submit instructions or user queries to large language models in web or application interfaces or other user interfaces in order to generate responses that take advantage of a deep understanding of natural language requests and the vast amount of information available to the LLMs. Users may authenticate with the LLM in a user session, for example, using a username and password, and the LLM may be configured to remember or not remember previous queries submitted by the user for answering later queries submitted by the user.

LLM sessions with a memory of prior queries and responses may emulate a natural conversation with the user where information already provided does not need to be repeated. LLMs are often used in chatbot implementations to improve capabilities of chatbots to account for open-ended questions that are not strictly within predefined pathways of the chatbots.

Applications often submit instructions to large language models via an application programming interface (API) of the LLM that is exposed for application consumption. The API may use an authentication token and/or other shared secret(s) that have been previously shared with an authenticated user managing the application to authenticate the application in current and future sessions with the LLM. The application may use the API to submit queries, which may be passed along from user queries, modified with additional problem solving constraints determined by the application, and/or augmented with other information determined by the application to provide a more applicable response from the LLM.

Augmenting Natural Language Queries with Context Relevant to the Queries

Instructions to an LLM may include contextual information or “context” that informs the LLM with specialized information relevant to the problem specification that may not be available to the LLM or may not receive a proper emphasis by the LLM. The LLM uses the context as well as information otherwise available to the LLM to generate a context-informed response to the instructions. If the context-informed response is not applicable to the use case, the application or user may revise the instructions to include additional context and/or problem-solving constraints until the LLM response is appliable to the use case. Such back-and-forth between the LLM caller (user or application) and LLM can be applied in many different scenarios to generate refined responses from the LLM that account for specialized instructions and specialized contextual information.

Large volumes of available contextual information may be initially narrowed down to relevant context based on how similar the context is to the application or user query. For example, a cosine similarity or any other similarity measure may be determined between a vector embedding of the query and vector embeddings of passages of context. Passages may include a body of text that has one or more paragraphs or sections of text, and each paragraph or section may include one or more clauses. Passages may also include a title that may be stored at the beginning of the body of text or separately from the body of text. As a result of the initial high-level filtering, passages potentially relevant to the query may remain, and passages not potentially relevant to the query may be pre-filtered. The fact that a passage may be relevant to a query does not determine which parts of a passage to add as context to the query. The most relevant parts of passages may be added to support guided answers to the query that take into account information presented in the most relevant parts of the passages.

Although context may be added to queries, adding too much context to a natural language query may confuse the natural language processing system with an overemphasis on redundantly provided context, an overemphasis on context irrelevant to the query, or an underemphasis on highly relevant context buried with context that is less relevant. Adding too much context may confuse the natural language processing system on the overall instructions requested of the query, and adding too much context may confuse the natural language processing system to provide an overly complicated or overly nuanced answer to a simple question. For these reasons and others, pruning context to be added may help focus on the natural language processing system, such as a large language model, on how to answer the query based on relevant information without confusing the natural language processing system with less relevant or redundant information.

Retrieval-Augmented Generation improves various aspects of large language models (LLMs) generation, but suffers from computational overhead caused by long contexts, and the propagation of irrelevant retrieved information into generated responses. Context pruning deals with both aspects by removing irrelevant parts of retrieved contexts before LLM generation. Context pruning according to the techniques described herein is efficient or robust enough to be useful in a wide range of scenarios, such as when contexts contain a variable amount of relevant information or vary in length, or when evaluated on various domains, and without requiring multiple round trips to the LLM for each query. In one embodiment, a context pruning system prunes and re-ranks retrieved relevant contexts to efficiently and robustly answer questions. The context pruning system may dynamically detect the needed amount of pruning for a given context and can be used without additional customization or specialization for various domains. The context pruning system may approach the context pruning task as sequence labeling, and may unify context pruning capabilities with context re-ranking, with training on diverse data. The context pruning system may perform context pruning with negligible to no drop in accuracy as compared to more computationally intensive techniques, in various domains and settings, with little or no additional latency in a Retrieval Augmented Generation (RAG) pipeline.

RAG has become a widely-used paradigm for improving factuality, attribution, and adaptability of large language models (LLMs). Augmenting a given user's query with retrieved relevant contexts helps to avoid the generation of untruthful information and enables the provision of references used to generate the answer. Furthermore, using a domain-specific datastore may enable access and reasoning over a previously unknown knowledge—without fine-tuning the LLM. One more important advantage of the RAG approach is a plug-and-play architecture. Practitioners may choose components (retrievers, generator LLMs, etc.) which best suit their particular use cases to optimize performance.

At the same time, the use of RAG adds computational overhead due to the increased input length and may also propagate irrelevant information present in retrieved contexts into generated responses. These issues can be solved by developing more efficient and robust LLMs—either by making architectural changes to process long contexts more efficiently or increasing the diversity of the tuning data to improve processing of irrelevant contexts. However, tuning the LLM can be highly resource-consuming, or even impossible to apply for proprietary (closed) LLMs. An alternative solution includes pruning retrieved contexts by removing context parts irrelevant to the user's query, which reduces context lengths and therefore speeds up generation tasks by the LLM. Such context pruning can be used in a plug-and-play manner with any generator LLM in the RAG pipeline.

In one embodiment, a context pruning system is robustly able to support zero, one, two, or more clauses as potentially relevant to the input query, depending on the query, rather than a fixed number or percentage of clauses. In practice, contexts may contain various portions of relevant information, from empty to full relevant context, and the context pruning system may detect this varying context in an adaptable fashion. The context pruning system may also be efficient to use by avoiding multiple calls to the LLM per query. The context pruning system may avoid using billion-size LLMs as base models and instead relies on more compact models (such as BERT-based models). The context pruning system may also avoid designing abstractive context compressors that involve sequential autoregressive generation of the final context and instead relies on an extraction of contextual clause(s) from the context without generating the contextual clauses anew. The BERT-based model may be used as an extractive pruner, i.e., with a lightweight prediction head for selecting relevant context parts. The context pruning system is also robust in the sense that the context pruning system may not require training on separate datasets and applies to various data domains based on the models, system architecture, and training data used to initially train the context pruning system.

The pruning granularity (i.e., token-level vs clause-level (also referred to as sentence-level) pruning) may vary across pruners. In one embodiment, the context pruning system uses query-dependent clause-level pruning, which prunes out semantic units (clauses or sentences) that are deemed not relevant to generate the answer. An alternative approach is token-level pruning which prunes out low-level grammatical units such as articles or interjections. Such pruning may or may not occur in a query-independent fashion. The two approaches are orthogonal and may also be combined for token-level and clause-level pruning.

In one embodiment, the context pruning system is an adaptable, efficient and robust clause-level context pruner for question answering, which, once trained, can be used without customization across various domains and settings. The context pruning system may use binary sequence labeling to generate a binary mask predicted by the context pruning system. The binary mask may store a determination of which clauses (from zero to all) are relevant to the query. The context pruning system may be trained from a lightweight DeBERTa model on diverse data. In a particular embodiment, due to an overlap in process between context pruning of clauses and re-ranking of passages, the context pruning of clauses may be combined with the re-ranking of passages into a single process using a single model, eliminating added latency of context pruning in the RAG pipeline.

The context pruning system may be tested against various QA domains to show applicability without customization to prune contexts with negligible to no drop in accuracy and at almost no cost, substantially outperforming other approaches. The context pruning system may detect the number of relevant sentences at any positions in the context and is robust to various context lengths.

In various examples, a Retrieval Augmented Generation (RAG) pipeline may include five stages: (0) a user's or application's question, or query; (1) a datastore, i.e., a collection of documents (pieces of text) to be retrieved, (2) an efficient but coarse retriever which enables fast retrieval of potentially relevant passages from a large datastore (which may be a dual-encoder model, where queries and passages are encoded independently) for example, using cosine similarity between a query embedding and data items (e.g., passages or paragraphs) from the data store, (3) a more expensive cross-encoder re-ranker which further reduces, from the text retrieved by the coarse retriever and re-orders a set of retrieved passages (cross-encoding means encoding a passage together with a query); and (4) a generator LLM which takes as input the user's query and the selected relevant passages and outputs the final response. The context pruning system may include, at stage (3), a combined pruner and re-ranker that generates as output a binary mask denoting which clauses should be kept in the passage as well as a determining a re-ordering or re-ranking of the passages, or as a standalone context pruner between stages (3) and (4), after or even before a separate re-ranking has been performed.

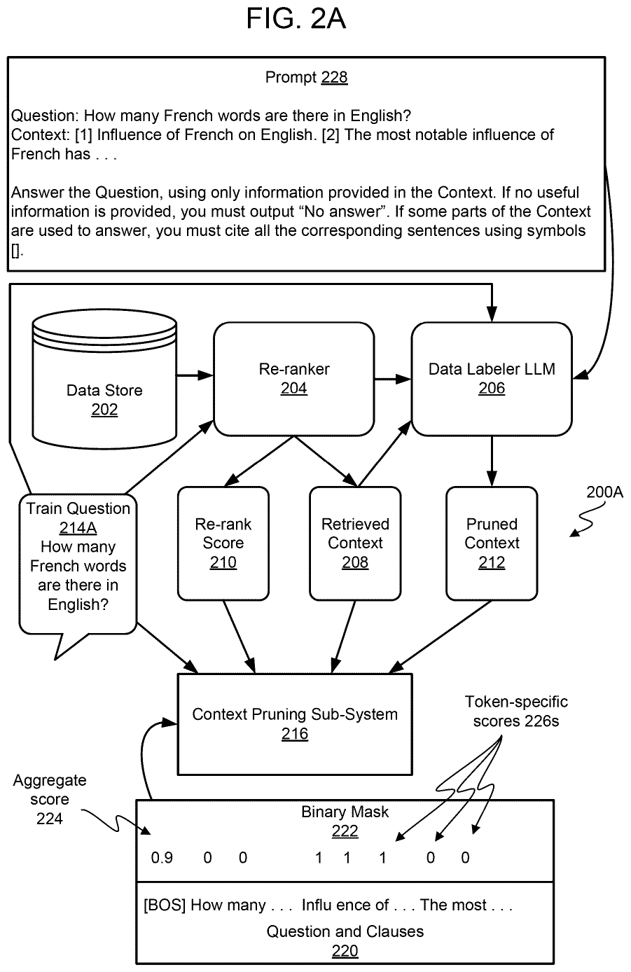

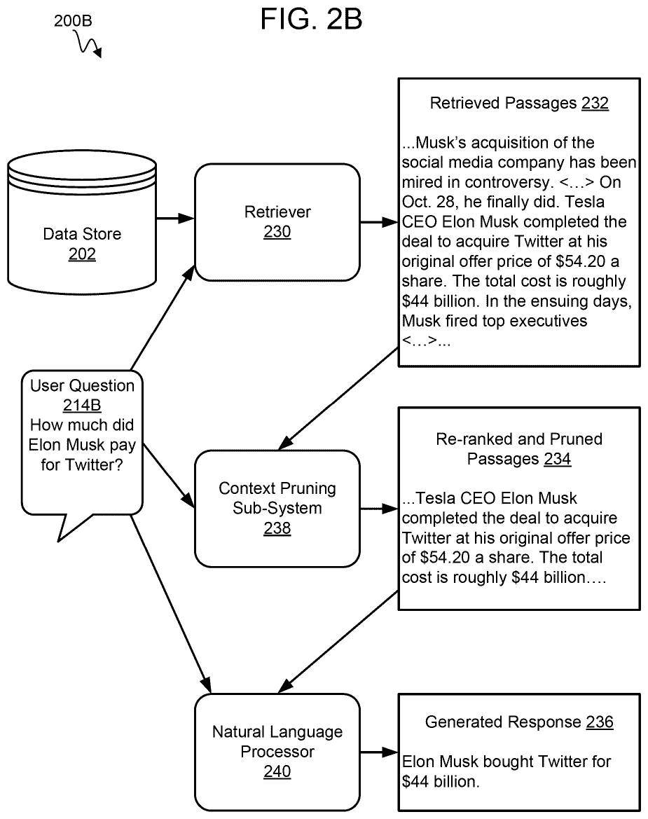

FIG. 2B illustrates a system diagram showing a context pruning system 200B that efficiently and robustly prunes context for retrieval augmented generation. In the example shown in FIG. 2B, a query or user question 214B is received, such as “How much did Elon Musk pay for Twitter?” An embedding of the query may be used by a retriever 230 to find, from data store 202, passages with embeddings that are similar to the query. In the example, the retrieved passages 232 may include the text, “Musk's acquisition of the social media company has been mired in controversy. < . . . > On October 28, he finally did. Tesla CEO Elon Musk completed the deal to acquire Twitter at his original offer price of $54.20 a share. The total cost is roughly $44 billion. In the ensuing days, Musk fired top executives< . . . >.” The retrieved passages 232 may be fed into a context pruning sub-system 238, which may prune and re-rank the passages to result in re-ranked and pruned passages 234 including preserved text: “Tesla CEO Elon Musk completed the deal to acquire Twitter at his original offer price of $54.20 a share. The total cost is roughly $44 billion.” The preserved text may be provided to a natural language processor 240 as context along with the query 214B, and the natural language processor 240 may generate a response 236 to the query such as “Elon Musk bought Twitter for $44 billion.”

Training a Model to Re-Rank and/or Prune Context Using a Clause-Level Analysis

FIG. 2A illustrates a system diagram showing a context pruning system for training a context pruning sub-system 238 shown in FIG. 2B that efficiently and robustly prune context for retrieval augmented generation. In the example shown in FIG. 2A, a data store 202 of contextual content may be used to perform retrieval and re-ranking. In one example, the retrieval and re-ranking is performed using a pre-trained model. The retrieval and re-ranking may be performed using a sample of example training questions 214As, such as “How many French words are there in English?” The example training question 214A is used by the retriever and re-ranker 204 to retrieve passages using a base model that compares vector embeddings of the content from data store 202 with a vector embedding of the question 214A to find similar content. Initially for retrieval and reranking, the similarity threshold may be low, resulting in an over-inclusion of passages that may be similar to the query.

During training, the retrieved context 208 of passages may be provided as context to a data labeler large language model (LLM) 206, such as in example prompt 228 where different clauses are numbered with a marked number using a marker such as “[ ]” or some other marker or symbol that has been filtered from the input text or is otherwise unlikely to occur in the clauses:
“Question: How many French words are there in English?
Context: [1] Influence of French on English. [2] The most notable influence of French has . . . Answer the Question, using only information provided in the context. If no useful information is provided, you must output “No answer.” If some parts of the Context are used to answer, you must cite all the corresponding sentences using symbols [ ]. Do not cite any sentences that are not used to answer.”

The data labeler LLM 206 may generate training responses to the training prompts using significant computing time and resources, but these training responses may be generated without human intervention. In one example, a robust and comprehensive larger and more computationally intensive data labeler LLM such as Llama-3-8B determines ground truth labels so a smaller model with fewer parameters may be trained based on the labels. Also, the time and resources expended during the training phase do not need to be expended at a later phase with the large language model.

In one embodiment of the context pruning sub-system 238 shown in FIG. 2B, the context pruning sub-system 216 of context pruning system 200A is trained using Llama-3-8B to provide ground truth labels. Given a question 214A and a retrieved passage (context) 208, the passage may be split into clauses, and Llama-3-8B may be prompted to select clauses relevant to the given question. Such an approach does not require human input and allows training to proceed more efficiently than manual labels. Example prompt 228 is shown in FIG. 2A. Another example prompt instruction to Llama-3-8B is “Output indexes of sentences relevant to the given question”. By using these results as ground truth labels, the context pruning system utilizes a strong LLM's capabilities of answering questions, and to instruct an LLM to answer the given question and to cite relevant context sentences in its response. Particularly, the context pruning system 200A may instruct the LLM to answer the given question using only information provided in the given context, and output “No answer” in case no relevant information is provided. The context pruning system 200A may also specify an easy-to-parse citation format [i] and number sentences with the same marker in the context. Cited sentences may be parsed using regular expressions.

Llama-3-8B is capable of answering only based on a given context in most cases and of outputting a citation in approximately 90% of cases. Cases when no citations are produced and “No answer” is not present in the LLM's output may be filtered out, as these are the cases when the context contains relevant information, but the LLM “forgot” to cite it or did not cite it correctly according to the instructions.

For training purposes, an LLM may be prompted in different ways to determine what context should be pruned and generate ground truth labels. In one example shown in FIG. 2A, the LLM is asked to answer a given question from a given context, citing corresponding sentences. In another example, an LLM may be asked to list any relevant information in the context to the question, citing corresponding sentences. In yet another embodiment, an LLM may be asked to output indexes of sentences which answer the given question. Different training may be performed in different scenarios and with different datasets.

As shown in FIG. 2A, re-ranker 204 generates a re-rank score 210 and retrieved context 208, and data labeler LLM 206 generates a pruned or preserved context 212 to inform context pruning sub-system of ground truth labels for training. Context pruning sub-system 216 trains a model to emulate the ground truth labels from data labeler LLM and to approach the re-rank score 210 from retriever and re-ranker 204. Context pruning sub-system uses the ground truth labels to increase or decrease weights of tokens that were similar to the query depending on whether the data labeler LLM determined to preserve or prune the clause, resulting in token-specific scores 226s of the clause. Aggregate score 224 (e.g., a passage-to-query relevance score) of the passage may be computed using a linear layer on top of an embedding of a [BOS] token output by a re-ranking head (as discussed in more detail below). Aggregate score 224 may be trained to approach the ground truth labels from re-ranker 204. Token specific scores 226s form a binary mask 222 for the question and clause 220. The binary mask 222 and aggregate score 224 may be combined as model output, which may be used to determine which clause(s) and/or passage(s) to prune or retain. During inference, as shown in FIG. 2B, context pruning sub-system 238 trained as context pruning sub-system 216 in FIG. 2A, which comprises a combined pruner and re-ranker that generates binary mask 222 for denoting which clauses should be kept in retrieved passages 232 as well as an aggregate score 224 for determining a re-ranking of the passages for output as re-ranked and pruned passages 234.

In one example, context pruning may be performed as a sequence labeling task by fine-tuning a compact model, such as a DeBERTa model, to encode the query-context pair, and output binary masks which are used to filter out irrelevant context parts. The silver labels or ground truth labels for training may be generated by Llama-3-8B (AI@Meta, 2024). In various examples, the model is able to deal with varying noise in contexts and select an appropriate pruning ratio. Queries may be encoded together with context sentences (cross-encoding), providing richer representations compared, for example, to an extractive RECOMP model that may encode query and context sentences independently. The context pruning system uses a lightweight encoder that leads to more efficiency than LLM-based or abstractive methods.

In one embodiment, the context pruning system in FIG. 2A uses a set of training questions and a retrieval datastore to train a model for re-ranking and pruning context. In a particular embodiment, the context pruning system uses a training set of the MS MARCO document ranking collection, which includes 370 k queries. Additional details about the MS MARCO collection are found in Nguyen, T., Rosenberg, M., Song, X., Gao, J., Tiwary, S., Majumder, R., & Deng, L. (2016 November). MS MARCO: A human generated machine reading comprehension dataset. Microsoft Research. Retrieved from https://www.microsoft.com/en-us/research/publication/ms-marco-human-generated-machine-reading-comprehension-dataset/, accessed Dec. 7, 2024, the entire contents of which are incorporated by reference herein for all purposes as if fully set forth herein. The MS MARCO collection or any other training data used may be a domain-diverse datastore crawled from the Web, which promotes the final model's robustness to various domains, and may be used to train retrievers and re-rankers. In one embodiment, a training set of Natural Questions (NQ, 87 k queries) may be used, such as the questions from Kwiatkowski, T., Palomaki, J., Redfield, O., Collins, M., Parikh, A., Alberti, C., Epstein, D., Polosukhin, I., Devlin, J., Lee, K., Toutanova, K., Jones, L., Chang, M.-W., Dai, A. M., Uszkoreit, J., Le, Q., & Petrov, S. (2019). Natural Questions: A benchmark for question answering research. Retrieved from https://huggingface.co/datasets/facebook/kilt_tasks, the entire contents of which are incorporated by reference herein for all purposes as if fully set forth herein.

Retrieval datastores may be formed by splitting MS MARCO documents or another diverse dataset into passages of k consecutive sentences, where k is randomly selected in a range, such as 1-10. The random selection of k promotes robustness for the pruner to variable retrieved context lengths. Page titles may be prepended to each passage and preserved through the pruning process as long as at least one clause of the passage is preserved. For each question, the context pruning system retrieves top-5 or top-N relevant passages using a strong retrieval pipeline that may include, for example, a SPLADE-v3 retriever and a DeBERTa-v3 re-ranker. Additional information about setting up a retrieval pipeline may be found in Rau, D., Déjean, H., Chirkova, N., Formal, T., Wang, S., Nikoulina, V., & Clinchant, S. (2024). Bergen: A benchmarking library for retrieval-augmented generation. Retrieved from https://arxiv.org/abs/2407.01102, the entire contents of which are incorporated by reference herein for all purposes as if fully set forth herein. Additional information about a SPLADE-v31 retriever may be found in Lassance, C., Déjean, H., Formal, T., & Clinchant, S. (2024). SPLADE-v3: New baselines for SPLADE, the entire contents of which are incorporated by reference herein for all purposes as if fully set forth herein. Additional information about the DeBERTa-v3 re-ranker may be found in Lassance, C., Déjean, H., Formal, T., & Clinchant, S. (2024). SPLADE-v3: New baselines for SPLADE, the entire contents of which are incorporated by reference herein for all purposes as if fully set forth herein. The resulting set of retrieved passages may be naturally diverse with respect to relevance or irrelevance to the question, due to imperfections of retrieval and using top-5 or top-N passages.

The context pruning system may be trained using Py-Torch (Paszke et al., 2019) and HuggingFace transformers (Wolf et al., 2020). Additional details on training using Py-Torch are provided in Paszke, A., Gross, S., Massa, F., Lerer, A., Bradbury, J., Chanan, G., Killeen, T., Lin, Z., Gimelshein, N., Antiga, L., Desmaison, A., Köpf, A., Yang, E., DeVito, Z., Raison, M., Tejani, A., Chilamkurthy, S., Steiner, B., Fang, L., Bai, J., & Chintala, S. (2019). PyTorch: An imperative style, high-performance deep learning library. Curran Associates Inc., the entire contents of which are incorporated by reference herein for all purposes as if fully set forth herein. Additional details on training using HuggingFace transformers are provided in Wolf, T., Debut, L., Sanh, V., Chaumond, J., Delangue, C., Moi, A., Cistac, P., Rault, T., Louf, R., Funtowicz, M., Davison, J., Shleifer, S., von Platen, P., Ma, C., Jernite, Y., Plu, J., Xu, C., Le Scao, T., Gugger, S., Drame, M., . . . . Rush, A. (2020). Transformers: State-of-the-art natural language processing. In Q. Liu & D. Schlangen (Eds.), Proceedings of the 2020 Conference on Empirical Methods in Natural Language Processing: System Demonstrations (pp. 38-45). Association for Computational Linguistics. https://doi.org/10.18653/v1/2020.emnlp-demos.6. Retrieved from https://aclanthology.org/2020.emnlp-demos.6 on Dec. 7, 2024, the entire contents of which are incorporated by reference herein for all purposes as if fully set forth herein.

In one embodiment, a compact model such as DeBERTav3 or another BERT-based model or compact model is used as a pretrained model for training the standalone context pruning system. Additional details about the DeBERTav3 model are provided in He, P., Gao, J., & Chen, W. (2021). DeBERTaV3: Improving DeBERTa using ELECTRA-style pre-training with gradient-disentangled embedding sharing, the entire contents of which are incorporated by reference herein for all purposes as if fully set forth herein.

In one embodiment, the context pruning system includes combined re-ranking functionality. In this embodiment, training may start from an already trained cross-encoder, also based on DeBERTa-v3. Additional information about the pre-trained cross-encoder is provided in Lassance, C., & Clinchant, S. (2023). Naver Labs Europe (SPLADE) @ TREC Deep Learning 2022. Retrieved from https://arxiv.org/abs/2302.12574 on Dec. 7, 2024, the entire contents of which are incorporated by reference herein for all purposes as if fully set forth herein. The ranking head (classifier) may be initialized from its pretrained version, and a separate pruning head may be trained from scratch.

In an example implementation, the learning rate may be set to 8×10⁻⁶, the batch size to 48, and models may be trained for one epoch. For joint training, there is a trade-off between pruning and re-ranking. In one example, the re-ranking regularization coefficient 2 may be set to 0.05, or 0.05±0.04, which is selected as a minimal value that does not substantially degrade re-ranking performance on the MS MARCO development set.

The context pruning system may be evaluated on a diverse set of QA datasets. For example, such QA datasets may include, but are not limited to:
For natural single-hop questions, Kwiatkowski, T., Palomaki, J., Redfield, O., Collins, M., Parikh, A., Alberti, C., Epstein, D., Polosukhin, I., Devlin, J., Lee, K., Toutanova, K., Jones, L., Chang, M.-W., Dai, A. M., Uszkoreit, J., Le, Q., & Petrov, S. (2019). Natural Questions: A benchmark for question answering research. Retrieved from https://huggingface.co/datasets/facebook/kilt_tasks, the entire contents of which are incorporated by reference herein for all purposes as if fully set forth herein.
For TyDi QA single-hop questions, Clark, J. H., Choi, E., Collins, M., Garrette, D., Kwiatkowski, T., Nikolaev, V., & Palomaki, J. (2020). TyDi QA: A benchmark for information-seeking question answering in typologically diverse languages. Transactions of the Association for Computational Linguistics, 8, 454-470. https://doi.org/10.1162/tacl_a_00317. Retrieved from https://aclanthology.org/2020.tacl-1.30 on Dec. 7, 2024, the entire contents of which are incorporated by reference herein for all purposes as if fully set forth herein.
For PopQA single-hop questions, Mallen, A., Asai, A., Zhong, V., Das, R., Khashabi, D., & Hajishirzi, H. (2023). When not to trust language models: Investigating effectiveness of parametric and non-parametric memories. In A. Rogers, J. Boyd-Graber, & N. Okazaki (Eds.), Proceedings of the 61st Annual Meeting of the Association for Computational Linguistics (Volume 1: Long Papers) (pp. 9802-9822). Association for Computational Linguistics. https://doi.org/10.18653/v1/2023.acl-long.546. Retrieved from https://aclanthology.org/2023.acl-long.546 on Dec. 7, 2024, the entire contents of which are incorporated by reference herein for all purposes as if fully set forth herein.
For HotpotQA multi-hop questions, Yang, Z., Qi, P., Zhang, S., Bengio, Y., Cohen, W., Salakhutdinov, R., & Manning, C. D. (2018). HotpotQA: A dataset for diverse, explainable multi-hop question answering. In E. Riloff, D. Chiang, J. Hockenmaier, & J. Tsujii (Eds.), Proceedings of the 2018 Conference on Empirical Methods in Natural Language Processing (pp. 2369-2380). Association for Computational Linguistics. https://doi.org/10.18653/v1/D18-1259. Retrieved from https://aclanthology.org/D18-1259 on Dec. 7, 2024, the entire contents of which are incorporated by reference herein for all purposes as if fully set forth herein.

Datasets with datastores from various domains may also be considered, including, but not limited to:
For biomedical questions with Pubmed as a datastore, BioASQ, Nentidis, A., Katsimpras, G., Krithara, A., Lima-López, S., Farré-Maduell, E., Gasco Sanchez, L., Krallinger, M., & Paliouras, G. (2023). Overview of BioASQ 2023: The Eleventh BioASQ Challenge on Large-Scale Biomedical Semantic Indexing and Question Answering. In Proceedings of the BioASQ 2023 Challenge (pp. 227-250). Springer. https://doi.org/10.1007/978-3-031-42448-9_19. ISBN 978-3-031-42447-2, the entire contents of which are incorporated by reference herein for all purposes as if fully set forth herein.
For questions about educational course logistics, with course syllabus as a datastore, SyllabusQA, Fernandez, N., Scarlatos, A., & Lan, A. (2024). SyllabusQA: A course logistics question answering dataset. In L.-W. Ku, A. Martins, & V. Srikumar (Eds.), Proceedings of the 62nd Annual Meeting of the Association for Computational Linguistics (Volume 1: Long Papers) (pp. 10344-10369). Association for Computational Linguistics. https://doi.org/10.18653/v1/2024.acl-long.557. Retrieved from https://aclanthology.org/2024.acl-long.557 on Dec. 7, 2024, the entire contents of which are incorporated by reference herein for all purposes as if fully set forth herein.
For questions about news with Google-searched news as contexts, RGB, Chen, J., Lin, H., Han, X., & Sun, L. (2024). Benchmarking large language models in retrieval-augmented generation. Proceedings of the AAAI Conference on Artificial Intelligence, 38(16), 17754-17762. https://doi.org/10.1609/aaai.v38i16.29728. Retrieved from https://ojs.aaai.org/index.php/AAAI/article/view/29728 on Dec. 7, 2024, the entire contents of which are incorporated by reference herein for all purposes as if fully set forth herein.

In one embodiment, the context pruning system is trained using a document-level MS MARCO dataset provided by Craswell, N., Mitra, B., Yilmaz, E., Campos, D., & Lin, J. (2021). MS MARCO: Benchmarking ranking models in the large-data regime. Proceedings of the 44th International ACM SIGIR Conference on Research and Development in Information Retrieval (SIGIR '21), 1566-1576. Association for Computing Machinery. https://doi.org/10.1145/3404835.3462804, the entire contents of which are incorporated by reference herein for all purposes as if fully set forth herein. The context pruning system may split each page into overlapping chunks of N sentences or clauses where N is a random number such as between 1 and 10 (with higher probabilities of longer contexts), in order to train the context pruning system on various context lengths. Each chunk may be prepended with a page title to preserve a background of the chunk. The resulting datastore size may be 34M passages. In one embodiment, the context pruning system uses a Wikipedia datastore prepared in a similar fashion. In one example, the Wikipedia datastore uses a 2024 Wikipedia data dump and processes the data dump using scripts provided by Lin, J., Ma, X., Lin, S.-C., Yang, J.-H., Pradeep, R., & Nogueira, R. (2021). Pyserini: A Python toolkit for reproducible information retrieval research with sparse and dense representations. Proceedings of the 44th International ACM SIGIR Conference on Research and Development in Information Retrieval (SIGIR '21), 2356-2362. Association for Computing Machinery. https://doi.org/10.1145/3404835.3463238, the entire contents of which are incorporated by reference herein for all purposes as if fully set forth herein. The example Wikipedia data is accessible at Castorini. (n.d.). Experiments with Wiki corpora. GitHub. Retrieved from https://github.com/castorini/pyserini/blob/master/docs/experiments-wiki-corpora.md, the entire contents of which are incorporated by reference herein for all purposes as if fully set forth herein. Versions of the Wikipedia datastore may be prepared with passages of N clauses or sentences with overlaps of N/2 clauses or sentences, for testing the context pruning system's robustness to various context lengths.

For life sciences data, in one embodiment, the context pruning system uses a version of a Pubmed dataset provided by Hsia, J., Shaikh, A., Wang, Z., & Neubig, G. (2024). RAGGED: Towards informed design of retrieval-augmented generation systems. arXiv preprint arXiv:2403.09040. https://arxiv.org/abs/2403.09040, the entire contents of which are incorporated by reference herein for all purposes as if fully set forth herein, accessible at Hsia, J. (n.d.). RAGGED dataset. Hugging Face. Retrieved from https://huggingface.co/datasets/jenhsia/ragged. The RAGGED dataset includes 58M passages, extracted from Pubmed abstracts. Each passage (chunk) is prepended with page title.

For syllabus data, in one embodiment, the context pruning system uses SyllabusQA, and splits each syllabus (provided by the authors) into passages of 100 words.

Context retrieved by a retriever using a trained model may include any context that is potentially relevant to answering the query. Such context may be provided to a context pruning system for the purpose of determining which clauses to preserve and which clauses to prune from a prompt to a large language model in response to the query.

Pruning may be performed at a clause-level, such as a sentence-level, or at a token-level, such as a word, sub-word, or term of separate meaning. A clause is an independent phrase that may include one, two, or more tokens connected together to form a meaning. Clauses may be delimited from each other using periods, commas, semicolons, new lines, or other delimiters. Clauses may be detected based on delimiters or may be detected based on the occurrence of subjects and verbs in a structure of text according to language constructs. Any existing libraries or known techniques may be used to split text into clauses, sentences, or otherwise delimited chunks of contiguous text that can be preserved or pruned independently of other delimited chunks of contiguous text.

A token is a term or collection of character(s) and symbol(s) in language that has a meaning, such as a word. Some words represent different possible meanings, in which case an occurrence of the word may probabilistically be associated with one or more tokens. Some tokens may change the understood meaning of other tokens by increasing or decreasing the probability that the word refers to one tokenized meaning or another. For example, in the clause, “I hit the ball with the bat,” the tokens “hit” and “ball” may determine a particular probabilistic meaning of the term “bat” as “bat_sports:baseball:equipment,” as compared to the probabilistic meaning of the term “bat” in a sentence that does not use the token “hit” or “ball,” which may equally refer to “bat_animal:mammal:flying.”

Although the example involves inferring meaning of a token based on other tokens in the same clause, token meanings may also be inferred based on surrounding text in a same passage or a same paragraph of the passage, such that generic terms are determined to refer back or forward to more specific topics and enrich the meaning of clauses even if the specific topics are not referenced in a clause that is enriched with meaning from another clause. A passage is an article, book, chapter, document, page, or other collection of text from a particular source about particular topics. A paragraph of a passage is a collection of clauses organized textually delimited as paragraphs and/or size delimited as consuming an amount of space allocated for a paragraph (for example, a space consumed by a capped amount of characters or words). In one embodiment, clauses of a paragraph of a passage are encoded together with knowledge of meaning of other tokens in the passage or the paragraph such that similar terms used in the passage or the paragraph may take a similar meaning, and compatible terms (e.g., more generic or specific variations) are aligned in meaning.

Processing context at the token-level uses the probabilistic meaning of terms inferred from surrounding text. The tokens are treated as their highest probability variants, and a tokenized meaning can be inferred or abstracted from text expressed in natural language. Processing context at the sentence-level or clause level preserves the terms in the clause and a structure of the clause without rephrasing or reinterpreting the clause as a collection of highest probability tokens. When processing context at the clause level, the terms in the clause may be used to help infer how closely the sentence is related to other content and either including the clause as related or unrelated without determining sub-topics of the clause that are most related and sub-topics of the clause that are least related, and without abstracting and expressing a sub-meaning of the clause that does not literally occur in the text. For example, a passage having two clauses may state: “Tesla and Rivian manufacture electric cars in the United States. A range of 300+ miles is common.” Using token-level processing, the two clauses may be reduced to the following facts: “Tesla manufactures cars in the United States,” “Rivian manufactures cars in the United States,” and “Electric cars have a range of 300+ miles” or “Tesla and Rivian cars commonly have a range of 300+ miles.” Any of these meanings may be retained, ordered, or pruned separately.

Using clause-level processing, the two clauses include:
a first clause, “Tesla and Rivian manufacture electric cars in the United States” that is related to “electric vehicles,” “Tesla—electric vehicle manufacturer,” “Rivian—electric vehicle manufacturer,” and “United States—country,” based on tokens occurring in the clause in light of surrounding text, and
a second clause, “A range of 300+ miles is common” that is related to “electric vehicles,” “Tesla—electric vehicle manufacturer,” “Rivian—electric vehicle manufacturer,” “United States—country,” and “fuel economy,” based on tokens occurring in the clause in light of surrounding text.
   Using clause-level processing, any of these clauses may be retained, ordered, or pruned separately, for example, depending on a relevance to a received query. If a first query asks “what range do most electric vehicles have?,” the clause processing system may prune the first clause and retain the second clause, optionally also retaining a title or other first sentence of the passage, as relevant to the first query. If a second query asks, “Who manufactures electric vehicles in the United States,” the clause processing system may prune the second clause and retain the first clause, optionally also retaining a title or other first sentence of the passage, as relevant to the second query.

In similar queries but applying token-level processing, the token processing system may prune the first two facts (“Tesla manufactures cars in the United States” and “Rivian manufactures cars in the United States”) and retain the third fact “Electric cars have a range of 300+ miles.” For the second query, the token processing system may prune the third fact and retain the first two facts. In some scenarios, splitting up the facts into chunks as understood by the token processing system loses meaning and results in facts that are misrepresented or hallucinated. If more compression is used (e.g., a higher percentage of tokens getting eliminated) for token-level processing, facts are represented at a higher level of granularity, and overgeneralizations or misrepresentations of the facts may be even more common as subtle meaning is eliminated. For example, the phrase “A range of 300+ miles is common” may be compressed to “Electric cars' range is 300 miles,” which has a slightly different meaning. Clause-level processing carries less risk of hallucinated facts, as there is no intermediate rephrasing or recharacterization of content from the clauses regardless of compression level.

A context pruning system may prune at a clause level by scoring each token of a clause as relevant or irrelevant to a query. The context pruning system may be trained by a data labeler large language model to give higher weight to tokens that are present or similar between the query and the contextual clause when the clause is identified by the data labeler large language model as relevant and lower weight to tokens that are absent or dissimilar between the query and the contextual clause when the clause is identified by the data labeler large language model as irrelevant. If a sentence has more tokens that are similar to the query than tokens that are dissimilar to the query, or otherwise at or above a threshold number or percentage of similar tokens, then the sentence may be preserved by the context pruning system. If the sentence has more tokens that are dissimilar to the query than tokens that are similar to the query, or otherwise below (or at or below) a threshold number or percentage of similar tokens, then the sentence may be pruned by the context pruning system.

The context pruning system may receive as input a concatenation of a question and a retrieved context, and output per-token binary labels denoting whether each token (for example, defined by the pretrained model's tokenizer) should be included in the selected context. In one embodiment, a special token may be inserted at the beginning of each sentence, and labels may be predicted per-sentence for the special token based on other token labels in the sentence. The context pruning system may be trained as a binary per-token classifier with ground truth labels coming from the silver data labeling.

In various embodiments, if any clauses are preserved for a given passage, a selection of the first (title) passage clause may be included to provide an introduction to the preserved clause and to avoid ambiguity in understanding the context by the generator.

In one embodiment, each token of a clause is scored with a binary value of 0 or 1 depending on whether the token should be preserved (1) or pruned (0). For example, tokens more similar to the query (or with a similarity score at or above a threshold) may be marked to be preserved (1), and tokens less similar to the query (or with a similarity score below a threshold (or at or below a threshold) may be marked to be pruned (0). The score for each token may account for how the token is used in the clause, looking forward or back within the clause or to other clauses in a paragraph or passage of text, or to the query, to determine a most likely meaning of the clause in light of the surrounding text and the query. This meaning based on the surrounding text and query may be used to generate a vector embedding of the token, and the vector embedding of the token may be used to determine a similarity score for the token. For example, similarity may be estimated using a linear layer (such as a layer applied over the embedding of the token) or any other similarity measurement that may be used to determine similarity between the token and the query. Although the surrounding text is considered, the token's similarity score is for the token itself.

In one embodiment, the embeddings of the tokens are computed to already take the query into account, so that per-token scalar values are produced using a simple linear layer applied on top of the embeddings of the tokens. These scalar values may represent “per-token relevance scores” rather than just “per-token similarity scores” in the sense that the scores may also account for relevance to the query.

Clauses may be evaluated for similarity to the query based on an aggregate similarity score that is determined from the token similarity scores for tokens in the clause. The stored indications of whether the tokens are similar to the query or not may be stored as a binary mask for a clause containing the tokens, such that a clause having 10 tokens may have an array, vector, or set of 10 binary numbers or a merged binary number that represents the set of binary numbers. If a clause has more 1s than 0s, or at or above a threshold number or percentage of 1s, the clause is preserved. If the clause has more 0s than 1s, or at or below a threshold number or percentage of 1s (or at or above a threshold number or percentage of 0s), the clause is pruned.

A clause-level aggregate similarity score may be stored as a 0 or 1 to indicate whether the clause is to be pruned or preserved. Or, the clause-level aggregate similarity score may represent a percentage of 0s or 1s of tokens in the clause, such as 0.9, indicating that 90% of the tokens in the clause are preserved. The clause-level aggregate similarity score may alternatively be determined from an aggregate or average of the token-level similarity scores, such that token-level scores of 0.8, 0.6, 0.7, 0.8, and 0.6 result in a clause-level aggregate similarity score of 0.7. Whether determined as a percentage of 1s or as an average, a non-binary clause-level aggregate similarity score may be used to rank clauses.

A percentage of 1s or 0s, or an average or aggregate similarity score of tokens in the clause, may be stored as the clause-level aggregate similarity score. In one example shown in FIG. 2A, a special token, such as [BOS] (Beginning of Sequence), is prepended or otherwise added to the clause, from which a clause-level aggregate similarity score may be determined. Ranking scores of passages may be determined based on the clause-level aggregate similarity scores in the passages. Passages with clauses having higher percentages of similar tokens or with higher aggregate similarity scores may be ranked higher than passages with clauses having lower percentages of similar tokens or with lower aggregate similarity scores. The preserved clauses of the preserved passages may be stored in a list in rank order based on rank scores of the passages and/or aggregate similarity scores of the clauses.

Preserved clauses may be returned for inclusion along with the query in a prompt to a natural language processing system, and pruned clauses may be omitted from a list of clauses returned for inclusion in the prompt. The prompt including the list of clauses and the query may cause the natural language processing system to generate a context-specific response.

Some extractive context pruners may encode sentences in the query independently and then select top sentences with embeddings closest to the query embedding. In these embodiments, context understanding is limited due to independent processing of queries, and the context pruner is fixed in the amount of clauses to keep (specified as a hyperparameter, for example). In another embodiment, the context pruning system determines how many clauses to keep (from zero to all clauses) based on clause-level aggregate similarity scores, and the clauses may be encoded dependently on each other such that a semantic meaning of tokens present in one clause informs a semantic meaning of tokens present in another clause.

Some pruners rely on an inefficient autoregressive generation of the final context and could also hallucinate facts not present in the input context. In another embodiment, the context pruning system extracts context present in the input context to avoid such hallucinations and inefficiencies.

Returning to the example of FIGS. 2A and 2B, the context pruning system may assign a score, such as “1” for “similar to query” and “0” for “dissimilar to query” for each token in each clause retrieved. Scores across tokens of a clause may be aggregated to determine if the aggregate score for the clause is at or above a threshold for preserving the clause or whether the aggregate score is below the threshold. If the aggregate score is above the threshold, the clause may be preserved, and if the aggregate score is below the threshold, the clause may be pruned. The aggregate score may be tracked for each of the preserved clauses and used to rank passages containing the preserved clauses for inclusion as context. For example, the passages having preserved clauses with higher aggregate scores may be included earlier in the context, and the passages having preserved clauses with lower aggregate scores may be included later in the context.

The clauses of preserved context may be returned for inclusion into a prompt to a natural language processing system along with the query to generate a response that uses the context to provide a context-informed response to the query. The pruned clauses may not be included in the prompt, to avoid misleading the natural language processing system or introducing a “red herring” that encourages the natural language processing system to account for irrelevant information just because the information was provided as context with the query.

In various embodiments, the context pruning system may be trained either to perform token-level labeling (with clause or sentence rounding at inference) or to perform sentence-level or clause-level labeling. In the former case clause representations may be richer but the model is also trained to output similar predictions for tokens inside one clause. In the latter case, clause content may be represented in a single embedding, which could limit representation expressivity. The token-level strategy may be used in some scenarios with some datasets, and the clause-level strategy may be used in other scenarios with other datasets.

In one example, benchmarking of the context pruning system may be performed using BERGEN, a benchmarking library for RAG, using the recommended hyperparameter settings. Additional details about BERGEN benchmarking may be found in Rau, D., Déjean, H., Chirkova, N., Formal, T., Wang, S., Nikoulina, V., & Clinchant, S. (2024). Bergen: A benchmarking library for retrieval-augmented generation. Retrieved from https://arxiv.org/abs/2407.01102, the entire contents of which are incorporated by reference herein for all purposes as if fully set forth herein. For each query, the top-5 or top-N relevant passages may be retrieved using a strong and robust retrieval pipeline such as a SPLADE-v3 retriever and DeBERTa-v3 re-ranker (except RGB where Google-searched passages are provided by the data authors). Additional detail about SPLADE-v3 may be found in Lassance, C., Déjean, H., Formal, T., & Clinchant, S. (2024). SPLADE-v3: New baselines for SPLADE, the entire contents of which are incorporated by reference herein for all purposes as if fully set forth herein. Queries prepended may be passed with the relevant document (full length or pruned) into Llama-2-7B-chat or a robust LLM to generate answers. Each evaluation dataset may come with short keyword answers that can be used to evaluate responses using LLM-based evaluation. Additional detail on LLM-based evaluation may be found at Rau, D., Déjean, H., Chirkova, N., Formal, T., Wang, S., Nikoulina, V., & Clinchant, S. (2024). Bergen: A benchmarking library for retrieval-augmented generation. Retrieved from https://arxiv.org/abs/2407.01102 on Dec. 7, 2024, the entire contents of which are incorporated by reference herein for all purposes as if fully set forth herein. Compression may be measured as a portion of the context which was pruned out.

### Pruning Based on Query and Context

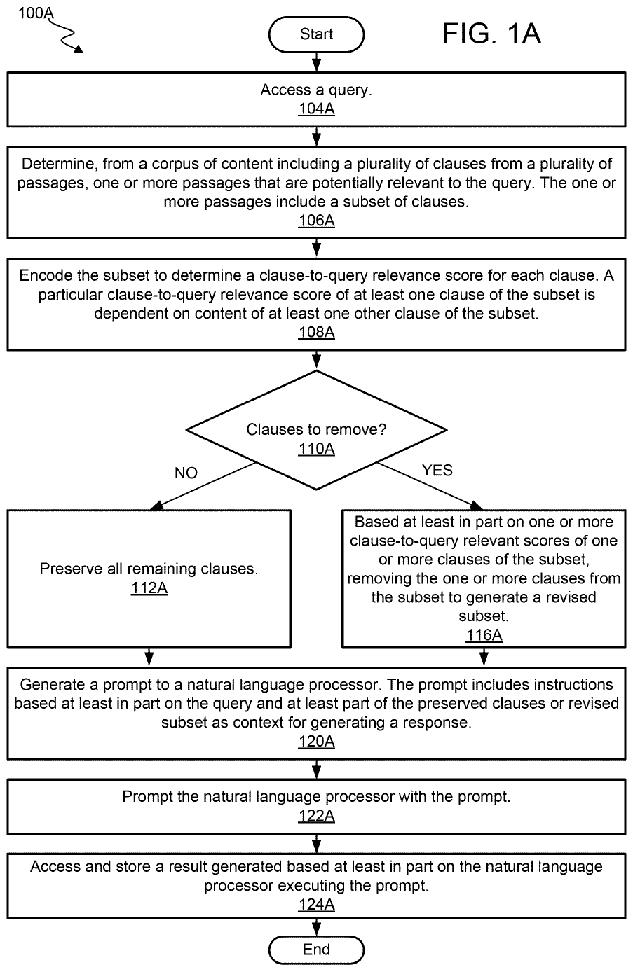

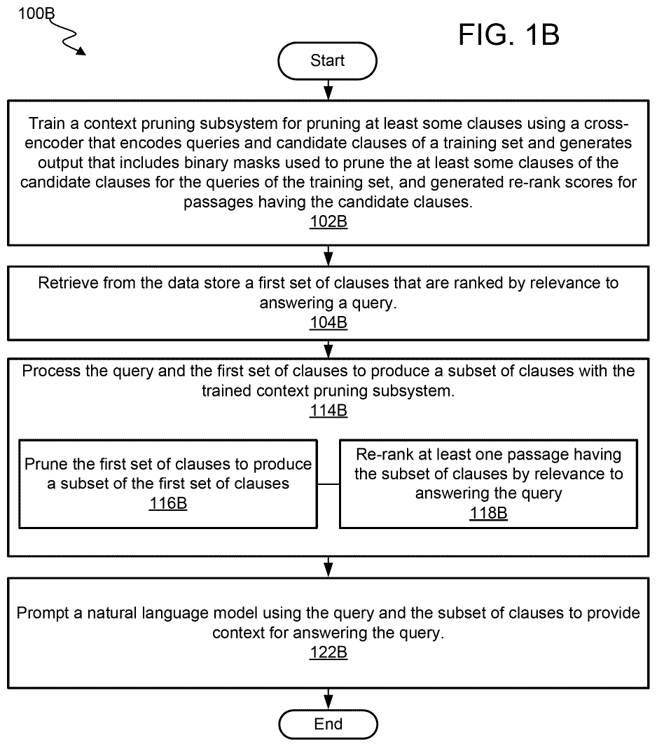

FIGS. 1A and 1B illustrate flow charts of example processes that efficiently and robustly prune context for retrieval augmented generation. Process 100A of FIG. 1A starts in block 104A where a context pruning system accesses a query. In block 106A, a retriever of the context pruning system determines, from a corpus of content including a plurality of clauses from a plurality of passages, one or more passages that are potentially relevant to the query. The one or more passages include a subset of clauses. In block 108A, a context pruning subsystem of the context pruning system encodes the subset to determine a clause-to-query relevance score for each clause. A particular clause-to-query relevance score of at least one clause of the subset is dependent on content of at least one other clause of the subset. In block 110, the context pruning subsystem determines whether there are any clauses to remove (i.e., prune). If no, all of the remaining clauses are preserved in block 112A. If yes, in block 116A, based at least in part on one or more clause-to-query relevance scores of one or more clauses of the subset, the context pruning subsystem removes the one or more clauses from the subset to generate a revised subset. In block 120A, the context pruning system generates a prompt to a natural language processor. The prompt includes instructions based at least in part on the query and at least part of the preserved clauses or revised subset as context for generating a response. Then, in block 122A, a natural language processor such as a large language model is prompted with the prompt. In block 124A, the context pruning system accesses and stores a result generated based at least in part on the natural language processor executing the prompt.

Process 100B of FIG. 1B starts in block 102B, where a context pruning system as shown in FIG. 2A trains a context pruning subsystem for pruning at least some clauses using a cross-encoder that encodes queries and candidate clauses of a training set and generates output that includes binary masks used to prune the at least some clauses of the candidate clauses for the queries of the training set, and generated re-rank scores for passages having the candidate clauses. In block 104B, the context pruning subsystem of the context pruning system retrieves, from the data store, a first set of clauses that are ranked by relevance to answering the query. In various other embodiments, a separate retrieval subsystem may perform retrieval of clauses for processing by the context pruning subsystem. In block 114B, the trained context pruning subsystem processes the query and the first set of clauses to produce a subset of clauses. In one embodiment, the trained context pruning subsystem is a neural network. Block 114B includes concurrently performing block 116B and block 118B. In block 116B, the context pruning subsystem prunes the first set of clauses to produce a subset of the first set of clauses. In block 118B, the context pruning subsystem re-ranks at least one passage having the subset of clauses by relevance to answering the query. Then, in block 122B, the context pruning system prompts a natural language processor using the query and the subset of clauses to answer the query with the benefit of added context from the subset of clauses.

In various embodiments, pruning may be done with or without information about a query received for which context is to be added. If the query is known to a context pruning system, a more specialized context specific to the query may be determined such that context irrelevant to the query may be removed even if the context is not redundant with other context. If the query is not known to the context pruning system, context is not pruned dependent on whether or not the context relates to the query. In this embodiment, context may be pruned as redundant with or not presenting new information than other content, but without an understanding of how closely the information being provided relates to the query. In other words, if an additional tokenized representation of facts does not change an existing meaning of other tokenized representation of facts, the additional tokenized representation of facts may be omitted as redundant regardless of how many clauses the facts occurred in and how the facts were worded in those clauses. If the additional tokenized representation of facts is not redundant, the additional tokenized representation of facts may be included as non-redundant.

Pruning to avoid redundancy or represent all tokenized facts may omit important information that is not fully captured in the tokenized representation of the facts, and such information may be retained if pruning at the clause level based on the query received. When pruning at the clause level based on the query received, information irrelevant to the query may be pruned. Clauses relevant to the query may be preserved, and clauses irrelevant to the query may not be preserved. A similarity between each individual clause and the query may be determined based on cosine similarity or any other similarity determination mechanism between embeddings of content.

The context pruning system may consume a concatenation of a question and a retrieved passage, and output probabilities of including each token in the final context, as well as the re-ranking score for the passage (or probabilities without the re-ranking score in case of a standalone model). A threshold T may be specified to binarize the token probabilities (keep or not), with probabilities above the threshold being kept and probabilities below the threshold being pruned.

### Context Pruning Examples

In various examples, a query is received from user or application input requesting a response generated at least in part by a natural language processing model or other large language model. The query is combined with context and processed using the natural language processing model to generate a result. For example, the query may state “what goes on the bottom of shepherd's pie”. A passage having an original context may be found with sufficient coarse-grained similarity to the query. In the example, the full text of the passage may include:
“Shepherd's pie. History. In early cookery books, the dish was a means of using leftover roasted meat of any kind, and the pie dish was lined on the sides and bottom with mashed potato, as well as having a mashed potato crust on top. Variations and similar dishes. Other potato-topped pies include: The modern ‘Cumberland pie’ is a version with either beef or lamb and a layer of breadcrumbs and cheese on top. In medieval times, and modern-day Cumbria, the pastry crust had a filling of meat with fruits and spices. In Quebec, a variation on the cottage pie is called ‘Pâté chinois”. It is made with ground beef on the bottom layer, canned corn in the middle, and mashed potato on top. The ‘shepherdess pie’ is a vegetarian version made without meat, or a vegan version made without meat and dairy. In the Netherlands, a very similar dish called ‘philosopher's stew’ ( ) often adds ingredients like beans, apples, prunes, or apple sauce. In Brazil, a dish called in refers to the fact that a manioc puree hides a layer of sun-dried meat.”

The context pruning system may consume this passage as discovered using the coarse-grained similarity filter to determine a subset of clauses in the passage, if any, that are relevant to the query. In the example, the context pruning system prunes the context down to the following text:
“Shepherd's pie. In early cookery books, the dish was a means of using leftover roasted meat of any kind, and the pie dish was lined on the sides and bottom with mashed potato, as well as having a mashed potato crust on top.”
   In the example, the context pruning system selects one sentence about Shepherd's pie and removes sentences about other similar dishes, rather than (a) removing all context, (b) removing too much context, (c) retaining too much context, (d) selecting the wrong context, or (e) hallucinating facts. The first clause, such as a title, is preserved to provide a background for understanding the preserved clauses.

In another example, a query is received that states “where does the sweetness of fruit come from”. A passage having an original context may be found with sufficient coarse-grained similarity to the query. In the example, the full text of the passage may include:
“Sweetness. A number of plant species produce glycosides that are sweet at concentrations much lower than sugar. The most well-known example is glycyrrhizin, the sweet component of licorice root, which is about 30 times sweeter than sucrose. Another commercially important example is stevioside, from the South American shrub ‘Stevia rebaudiana’. It is roughly 250 times sweeter than sucrose. Another class of potent natural sweeteners are the sweet proteins such as thaumatin, found in the West African katemfe fruit. Hen egg lysozyme, an antibiotic protein found in chicken eggs, is also sweet.”

The context pruning system may consume this passage as discovered using the coarse-grained similarity filter to determine a subset of clauses in the passage, if any, that are relevant to the query. In the example, after the pruning process, the context pruning system preserves all of the text from the passage without pruning any clauses out:
“Sweetness. A number of plant species produce glycosides that are sweet at concentrations much lower than sugar. The most well-known example is glycyrrhizin, the sweet component of licorice root, which is about 30 times sweeter than sucrose. Another commercially important example is stevioside, from the South American shrub “Stevia rebaudiana”. It is roughly 250 times sweeter than sucrose. Another class of potent natural sweeteners are the sweet proteins such as thaumatin, found in the West African katemfe fruit. Hen egg lysozyme, an antibiotic protein found in chicken eggs, is also sweet.”
   In the example, the context pruning system selects all context as relevant rather than (a) removing all context, (b) removing too much context, or (c) selecting the wrong context, or (d) hallucinating facts. The first clause, such as a title, is preserved to provide a background for understanding the preserved clauses.

In another example, a query is received that states “what was the tower of london originally used for”. A passage having an original context may be found with sufficient coarse-grained similarity to the query. In the example, the full text of the passage may include:
“Tower of London. In the 16th century, the Tower acquired an enduring reputation as a grim, forbidding prison. This had not always been the case. As a royal castle, it was used by the monarch to imprison people for various reasons, however these were usually high-status individuals for short periods rather than common citizenry as there were plenty of prisons elsewhere for such people. Contrary to the popular image of the Tower, prisoners were able to make their life easier by purchasing amenities such as better food or tapestries through the Lieutenant of the Tower. As holding prisoners was originally an incidental role of the Tower—as would have been the case for any castle—there was no purpose-built accommodation for prisoners until 1687 when a brick shed, a ‘Prison for Soldiers’, was built to the north-west of the White Tower. The Tower's reputation for torture and imprisonment derives largely from 16th century religious propagandists and 19th-century romanticists.”

The context pruning system may consume this passage as discovered using the coarse-grained similarity filter to determine a subset of clauses in the passage, if any, that are relevant to the query. In the example, the context pruning system prunes the context down to the following text:
“Tower of London. As a royal castle, it was used by the monarch to imprison people for various reasons, however these were usually high-status individuals for short periods rather than common citizenry as there were plenty of prisons elsewhere for such people.”
   In the example, the context pruning system selects the one most relevant clause in the passage rather than (a) removing all context, (b) removing too much context, (c) retaining too much context, (d) selecting the wrong context, or (e) hallucinating facts. The first clause, such as a title, is preserved to provide a background for understanding the preserved clauses.

### Pruning Multiple Passages

In various examples, a coarse-grained similarity filter may find multiple passages that are each potentially relevant to the query, and the content pruning system may analyze these passages in parallel (for example, using different content pruning system worker threads), together, in batches of passages, or serially to determine a preserved set of clauses, if any, for each passage. The preserved clauses for each passage may be combined together as context to submit with the query in order to generate a context-informed natural language response to the query.

In one scenario, context from the multiple passages may be ranked with clauses from a top-ranking passage appearing first and clauses from other passages appearing later in a prompt to a natural language processing system, with clauses grouped by passage. In another scenario, context from the multiple passages may be interleaved with top-ranking clauses appearing first and lower-ranking clauses appearing later regardless of which passage the clauses occurred in. In another scenario, context from the top-ranked passage, top-5 passages, or top-N ranked passages may be combined and provided to the natural language processing system as context for generating a result for the query.

In yet another scenario, context from each passage may be used in a separate call to the natural language processing system to generate separate results. The separate results may be merged using another call to the natural language processing system to determine a most common or most comprehensive result among the separate results. In another embodiment, the other call to the natural language processing system may use the separate results as a new context for a new query to the LLM re-posing the original question. In yet another embodiment, the separate results from the natural language processing system may be merged using a machine learning model or other logic that detects a most common result among the set of results, for example, based on which result has a vector embedding with a minimum total distance from vector embeddings of other results, without making another call to the natural language processing system.

### Tuning the Level of Pruning

In one embodiment, a model used by the context pruning system outputs token-level predictions despite the clause-level labeling task. Despite the token-level predictions, probabilities of including tokens into the final context may be naturally clustered on the clause level due to the clause-level targets used in training. However, in some cases partial clauses may still be selected or preferred. To determine whether to preserve a clause without risking losing meaning by dissecting the clause, the context pruning system may apply a “sentence rounding” or “clause rounding” procedure: for each clause, the context pruning system may check the ratio of kept tokens (predicted label=1) to total tokens, and select the entire clause if this percentage is higher than 0.5 (or some other specified and adjustable threshold) and drop the sentence otherwise.

The adjustable threshold for determining whether to preserve or prune a clause may be learned to approximate other, more computationally intensive pruning systems such as those that use expensive high-computation-cost large language models to determine what context to prune and what context to preserve. The adjustable threshold may additionally or alternatively be adjustable by a user, to provide more context-intensive responses to queries that may be more informed but slower to execute and potentially more confusing for the natural language processing system, or less context-intensive responses to queries that may be faster to execute but may lack relevant details that would be helpful to answer some queries. In the example, lowering the threshold may result in more clauses being preserved and fewer clauses being pruned, and raising the threshold may result in fewer clauses being preserved and more clauses being pruned.

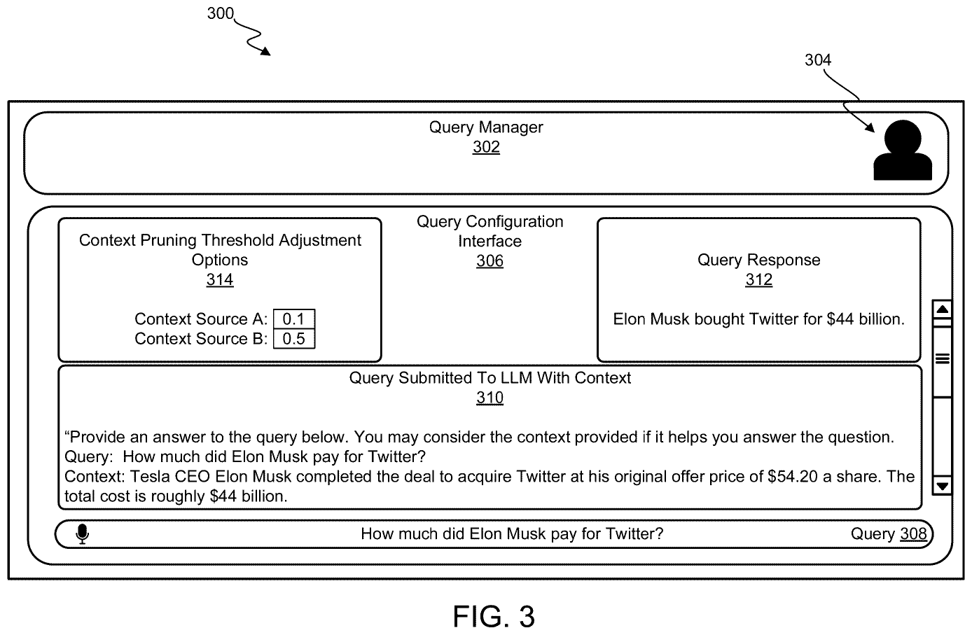

FIG. 3 illustrates a diagram of an example user interface 300 showing options to adjust thresholds to use for efficiently and robustly pruning context for retrieval augmented generation. As shown, query manager 302 may have an authenticated user 304 logged in to submit queries, view details, or adjust configuration settings. Query configuration interface 306 includes a query input region 308. A view of an augmented query submitted to the LLM with context 310 may be shown. Query configuration interface 306 may also show a query response 312 as received from the LLM. In the example, query configuration interface includes multiple options 314 for adjusting multiple context pruning thresholds, with different thresholds applied to different sources of context. The different sources may be identified based on content type, server, database, topic, etc., and the adjusted thresholds as specified in options 314 may be used by the context pruning system when pruning content from a passage that matches a corresponding source, type, topic, etc. In this manner, the user may control pruning behavior for different types of context.

Without specifying a specific threshold, user feedback may be incorporated to adjust the threshold higher or lower based on whether the user feedback indicates that important context or detail was left out (threshold too high) or that the response contained or was based on too much irrelevant information or was too slow (threshold too low). Different thresholds may be learned for different types of queries based on the user feedback, such that the threshold adapts as different queries are received and processed. In one embodiment, if the user provides positive or negative feedback (or just a flagged result) without indicating why, a large language model may be used with a full passage, the original query, and the original runtime provided as context to determine why the feedback was positive or negative or otherwise flagged, and update the threshold based on the reason determined by the large language model.

In various embodiments, the context pruning system is able to determine how many clauses from a collection of passages are relevant to include as additional context for a query based on how closely the sentences relate to the query and how redundant the clauses are with each other. Although the content pruning system is able to determine, query to query for large available collections of different passages, which passages are relevant and which clauses from the passages are relevant, such determination may be tuned by adjusting a threshold score for which a clause is to be considered relevant or irrelevant. For example, the score may be increased to prune more clauses and keep fewer clauses that are more highly relevant to the query and less redundant with each other; alternatively, the score may be decreased to prune fewer clauses and keep more clauses that are still determined to be relevant to the query and still determined not to be redundant with each other. In this manner, the context pruning system has the logic to determine how many clauses to keep or prune as well as the logic for adjusting how aggressively clauses are pruned without mandating that a specific number of clauses are kept or pruned from the passage(s) potentially relevant to the query.

In one embodiment, in addition to or alternative to adjusting a pruning threshold, training data is provided to the context pruning system to determine whether the context was over-pruned or under-pruned. Feedback may be provided to the model based on context pruning performed, and the feedback may be used to adjust an aggressiveness of pruning and/or to balance an importance or relative weight of limiting redundancy and a relative weight of more closely matching the query. For example, if query matching is weighed as more important, clauses less closely matching the query are pruned more aggressively. As another example, if limiting redundancy is weighed as more important, clauses that are similar to other unpruned clauses are pruned more aggressively. The feedback may be used to adjust an overall score given to each clause for pruning purposes, and the overall score may be based on the weight assigned to limiting redundancy, the weight assigned to query matching, the amount of redundancy for a clause in light of other clauses not pruned, and the amount of match between the clause and the query.

In one embodiment, the context pruning system is trained on a large language model such as GPT3, which receives a query and context and is prompted to determine using the large language model what portions of the context are most relevant to the query to be included in a prompt. The large language model may consume significant resources to determine an optimal context to select. A smaller model such as T5-L or DeBERTa may be trained with fewer parameters on an output of the large language model selection of context for retaining or pruning, where the large language model selection is treated as a source of truth and the smaller model is trained to emulate the source of truth. For example, the smaller model may be trained to predict an output of the large language model based on a limited set of parameters such as the embedding data about the context and query fed into the large language model for training.

In various embodiments, the context pruning system may vary the pruning ratio automatically according to the dataset (with examples varying from 50% to 80% of clauses pruned). The context pruning system may still vary according to the dataset when the pruning threshold T is adjusted, but more or fewer clauses will tend to be pruned depending on whether T is adjusted higher or lower. Example values of T were set at 0.1 and 0.5 and provided variable pruning within the same T value. Users may adjust T depending on the amount of pruning desired for a dataset. Some models specify the desired compression ratio as a hyperparameter, but adjusting T is not the same as adjusting a compression ratio because adjusting T does not provide any guarantee that any percentage of clauses will be pruned, not pruned, or pruned at a certain percentage for a given question-context pair. Instead, adjusting T adjusts how similar the clauses should be to the query in order to be kept or, conversely, how dissimilar they should be to be pruned. Different queries may have different ranges of similarity scores leading to different percentages of clauses being pruned for the same T.

Efficiency and Accuracy Gains from Pruning by Extraction without Incurring an Extra Round-Trip of Generative Abstraction

Various extractive approaches may remove clause(s) from the text while retaining other clause(s) in the text without incurring an extra round-trip of generative abstraction. The extra round-trip of generative abstraction not only causes extra expense in terms of time and resources to evaluate the large language model but also may change the meaning of the clauses and/or lose meaning reflected in the clauses as concepts from the clauses are merged together without case-specific guidance on how the clauses should be merged together. Generating the case-specific guidance would involve even more expense and would still run the risk of changing meaning or losing meaning otherwise reflected in the clauses themselves. Extractive approaches preserve clauses, optionally with slight grammatical, formatting, typographical, or other minor or non-semantic adjustments to the text, without attempting to merge different clauses together to generate a new more compact representation of the different clauses. The extracted clause(s) may be provided to a large language model as augmented context to execute a natural language query.

In various embodiments, one or multiple clauses may be preserved to preserve distinct meanings reflected by the multiple clauses, without losing context by eliminating a relevant but less relevant clause of the multiple preserved clauses. Although multiple clauses may be preserved, one or multiple other clauses may be removed from the text without diluting meaning(s) of the preserved clause(s) by attempting to generate a new abstract context using a large language model. Techniques that attempt to generate the new abstract context that accounts for clause(s) that may otherwise be removed from a set of contextual clauses may result in generating clauses that have diluted meaning that results from connecting related clauses that are not providing exactly the same factual details in the same way. Such diluted meaning may mislead a large language model by providing unhelpful context that does not include important fine-grained details of the separate clauses.

### Compact Architecture for Identifying and Pruning Potentially Relevant Context

The DeBERTa model and other BERT-based models or compact models having an order of millions, tens of millions, or hundreds of millions of parameters rather than billions of parameters or more can operate in high throughput, low cost, low latency, and high efficiency environments. Many BERT-based models have 100M, 200M, or fewer parameters. Other models, such as Mistral-7B, T5-XL, Alpaca-7B, Llama-7B, Llama-2-7B, or Llama-2-7B-chat have billions of parameters that lead to lower throughput, higher cost, higher latency, and lower efficiency. The DeBERTa model is publicly available for use in a wide range of applications, and the model or other compact models may be used for context pruning according to the techniques described herein. Additional details about the DeBERTa model may be found in He, P., Liu, X., Gao, J., & Chen, W. (2021). DeBERTa: Decoding-enhanced BERT with Dis-entangled Attention, Proceedings of the International Conference on Learning Representations (ICLR) 2021. Retrieved from https://openreview.net/forum?id=XPZlaotutsD on Dec. 7, 2024, the entire contents of which are incorporated by reference herein for all purposes as if fully set forth herein. DeBERTa incorporates and improves upon BERT and ROBERTa models. Additional details about the BERT model may be found in Devlin, J., Chang, M.-W., Lee, K., & Toutanova, K. (2019). BERT: Pre-training of deep bidirectional transformers for language understanding. Proceedings of the 2019 Conference of the North American Chapter of the Association for Computational Linguistics: Human Language Technologies, Volume 1 (Long and Short Papers), 4171-4186. Retrieved from https://aclanthology.org/N19-1423 on Dec. 7, 2024, the entire contents of which are incorporated by reference herein for all purposes as if fully set forth herein. Additional details about the ROBERTa model may be found in Liu, Y., Ott, M., Goyal, N., Du, J., Joshi, M., Chen, D., Levy, O., Lewis, M., Zettlemoyer, L., & Stoyanov, V. (2019). ROBERTa: A robustly optimized BERT pretraining approach. arXiv preprint arXiv:1907.11692. Retrieved from https://arxiv.org/abs/1907.11692 on Dec. 7, 2024, the entire contents of which are incorporated by reference herein for all purposes as if fully set forth herein.

Compact models are distinguished from open-ended models that prompt natural language processors with open-ended textual input to produce open-ended textual responses that may account for any information publicly available. Such open-ended models result in significant additional cost, latency, and lower throughput and lower efficiency, which makes them less applicable in high throughput or low cost scenarios.

Using compact or lightweight models may allow for retrieval augmented generation (RAG) with context pruning to be used in scenarios that involve a high number of prompts to a large language model, where each individual prompt and the logic used to generate the prompt is expected to consume a limited amount of resources that may be shared with a variety of workers who are generating prompts in parallel for different queries and potentially even different users across a cloud infrastructure. The lightweight models allow context-specific prompts to be generated without such context-specific prompts requiring another round-trip with a large language model and in such a manner that the large language model may provide a response transactionally for use in a synchronous operation that causes downstream steps to be performed based on a result from the large language model. Such synchronous operations may not be possible in scenarios that would otherwise involve multiple data-intensive round-trip calls to the large language model, and performing multiple round-trips per query may be prohibitively expensive due to the resources consumed by the large language model each round trip. The compact or lightweight models may allow context-specific queries that would otherwise be performed without context to avoid extra round trips with the large language model for a variety of reasons.

As shown in Table 1 below, the use of a compact model may result in better compression time and MFLOPS8 consumed by the context pruning system as compared to other pruning techniques. Pruners such as LongLLMLingua relying on LLama-2-7B-chat model were the slowest in pruning context. RECOMP abstractive may use less MFLOPS for pruning but is slower in practice due to its autoregressive nature. RECOMP extractive produces a fixed number or percentage of pruned clauses and is not adaptive. In the case of the joint model (context pruning system with re-ranking), pruning is almost free.

TABLE 1

| Pruner | Time (sec) | MFLOPS |
|---|---|---|
| LongLLMLingua, rate = 0.5 | 2649 | 122 × 10⁹ |
| LLMLingua2, rate = 0.5 | 863 | 8 × 10⁹ |
| RECOMP extractive, top = 2 | 351 | 1.2 × 10⁹ |
| RECOMP abstractive | 1056 | 2.2 × 10⁹ |
| Example Context Pruning | 471 | 4.8 × 10⁹ |
| System | | |

Table 2 below reports speed-up gains by a downstream large language model due to compression by the context pruning system (with an example compression rate of 50%). All runs were performed on single Tesla V100-SXM2-32 GB GPU with vllm10. With large batch sizes, the example context pruning system caused approximately 2× speed-up at inference, while with small batch sizes inference speed up was still significant.

TABLE 2

| Generator | Batch Size 1 | Batch Size 256 |
|---|---|---|
| LLama-2-7B | x1.2 | x2 |
| LLama-2-13B | x1.4 | x2 |
| SOLAR-10.7B | x1.4 | x1.9 |

In various embodiments, roberta-base (125M parameters) and/or roberta-large (355M parameters) models may be used, with slight differences in compression and/or efficiency.

The context pruning system is a robust, adaptable, and efficient context pruner for question answering, which may be unified in a single model with re-ranker or available as a lightweight standalone model. The context pruning system may dynamically detect the applicable pruning ratio for a given context and can be used for various QA domains. In various examples, the context pruning system accurately detects the number of relevant sentences in contexts, located at any position, and with contexts of various lengths. Some embodiments focus on QA applications with a single passage processed at a time, and other embodiments select passages for potential inclusion before processing the clauses of the passages for ranking and pruning.

### Context Pruning Across Domains

In various embodiments, the contextual pruning may be performed in multiple domains across multiple use cases for prompting a large language model or other natural language query processing system. A context remaining after pruning clauses from an initial context may be used to prompt the query processing system for information relating to different topics, using different domain-specific contextual passages, and/or in order to accomplish different tasks or generate content conforming to different result templates, patterns, or even from different models specialized to handle different types of questions. An initial query may be passed to a special-purpose model by analyzing the initial query and included context, which may have already been pruned according to techniques described herein. The analysis may match the query and included context against a set of example queries, example responses, instructional materials, metadata, or other information associated with different models for answering different types of questions. For example, the query and/or context may be matched to a closest model using cosine distance between information about the query and/or context and examples, metadata, or other information about the model.

In various embodiments, training may be performed on NQ (84K queries) and/or MS MARCO down-sampled to the same size or full MS MARCO (370 k queries). Using larger training data sets improves results but consumes more resources. Training on NQ data may reduce re-ranking performance, since NQ data is not a common type of data to train re-rankers. Supplementing training data from multi-domain datasets may improve results.

### Concurrently Ranking and Pruning Context

In one embodiment, re-ranking and context pruning are performed together, concurrently, instead of considering these steps as distinct in the Retrieval Augmented Generation (RAG) pipeline. Re-ranking and pruning may be done in a single forward step, thus eliminating the computational overhead due to context pruning and making the pruning step almost “free” if a re-ranking step would have been included in the process regardless of whether pruning was included or not.

The context pruning system may be implemented in various embodiments. In a standalone embodiment, a passage selection model, passage re-rank model, and clause selection model are trained separately. In a re-ranker embodiment, a passage re-rank model and clause selection model are trained together. In other words, the re-ranker embodiment uses one model with two different prediction heads on top of it, one head for passage re-ranking and one head for clause selection.

In one embodiment, the same model used to determine the binary mask for each token in a clause is also used to determine the clause-level aggregate similarity score and a re-rank score for a passage that includes preserved clauses. Because the token-level scores and the clause-level score are determined using the same model, the clause may be handled in a single pass, concurrently, through the model with a binary mask output that includes both the token-level scores and the clause-level score. The clause-level score may be used to determine the passage-level re-rank score that determines a rank or order of the passage among other passages with different scores.

In another embodiment, a first model is used for re-ranking, and a second model is used for pruning. This embodiment is more flexible to a variety of re-rankers but carries the expense of separate re-ranking and pruning steps. Assuming the re-ranking is performed prior to the pruning, the pruning could benefit from the additional information generated by the re-ranker and wait for that information to be provided. If the pruning were performed prior to the re-ranking, the re-ranking would not need to wait for the re-rank information but also would not benefit from it. Combining the re-ranking and pruning into the same step that is algorithmically determined concurrently retains the benefit gained from re-ranking information without the additional cost of pruning in a separate step.

In one embodiment, a combined re-ranker and pruner may be trained to imitate a separate re-ranker to determine similar re-rank scores. Once the combined re-ranker attains similar re-ranking scores, the separate re-ranker may be de-activated from the loop, with the combined re-ranker assuming re-ranking responsibilities on a forward-looking basis.

Cross-encoder re-rankers may share both the same architecture and inputs (pairs of question-passages) as the context pruning system. The task of context pruning (selecting parts of contexts that are useful for generating the answer to the question) may be accomplished using similar logic as re-ranking (estimating the relevance of a context with respect to the question), and the re-ranker embodiment of the context pruning system takes advantage of knowledge transfer between these two related tasks by unifying both approaches in a single model. The re-ranking head of the model outputs a scalar prediction for a [BOS] token, and the pruning head of the model outputs per-token predictions for the passage tokens. These outputs may be combined into the same binary object and be determined together clause-by-clause. The context pruning system may fine-tune a pretrained re-ranker on a particular labeling objective, while adding a ranking “regularizer” to preserve initial re-ranking capabilities. In one embodiment, the regularizer is a Mean Squared Error loss on the re-ranking scores from the initial re-ranker. This can be seen as a pointwise score distillation setting, where the initial model is the teacher. In one example, the final loss function is defined as:

$$L = {\sum }_{n = 1}^{N} \{ {\sum }_{k = 1}^{{L}_{n}} log P ( {y}_{n , k} \vert {z}_{n , k} ) + {λ ( {s}_{n} - {z}_{n , 0} )}^{2} \}$$

$$where {z}_{n} = Context Pruning System ( {x}_{n} )$$

where N is the number of datapoints (query-passage pairs), xₙ is a sequence of Lₙ₊₁ input tokens (concatenated query, passage and BOS at the 0-th position), zₙ is a sequence of Lₙ₊₁ predictions output by the model, yₙ is a sequence of Lₙ target binary labels for context pruning, Sn is the teacher score (initial re-ranker), and z_{n,0} is the ranking score predicted from the BOS representation.

### Triggering Downstream Activity as a Result of Context-Informed Natural Language Processing

Natural language queries such as prompts to large language models may be used to produce outputs that answer the queries. If pruned context is provided with a natural language query, the natural language query processor or large language model may use the pruned context to provide context-informed answers to the queries without separately training the large language model to account for any specific other context. The answers to the query may produce text such as a short answer that accounts for facts provided in the context or executable code that accounts for code libraries, APIs, or preferred protocols provided in the context. The answers may be used to display information on a display, cause information to be audibly spoken using a speech-to-text model by a computer or robot, cause action, such as physical action or electronic communication, to be taken by a computer or robot, and/or provide input to another model trained for a special purpose. The context may inform the large language model of a private or constrained problem space, provide knowledge about a specific environment, machinery operation or troubleshooting, or other technology, or provide other specialized knowledge applicable to a particular domain.

In various embodiments, answers to the query may produce text such as a short or long answer that accounts for facts or details, provided in the context. The answer and details accounted for may be task-related, user-related, or domain-related. Answers to the query may produce executable code that accounts for code libraries, APIs, or preferred protocols provided in the context. Answers to the query may produce structured data such as a JSON (JavaScript Object Notation) object or any other formatting of the data that accounts for the data elements provided in the context. The answer may be consumed by any downstream application for any purpose, including but not limited to triggering actions, displaying corresponding information to the user, causing operation of equipment according to the executable code or other instructions received with the answer, and/or for prompting a large language model for further information or interacting with another API.

### Computer System Architecture

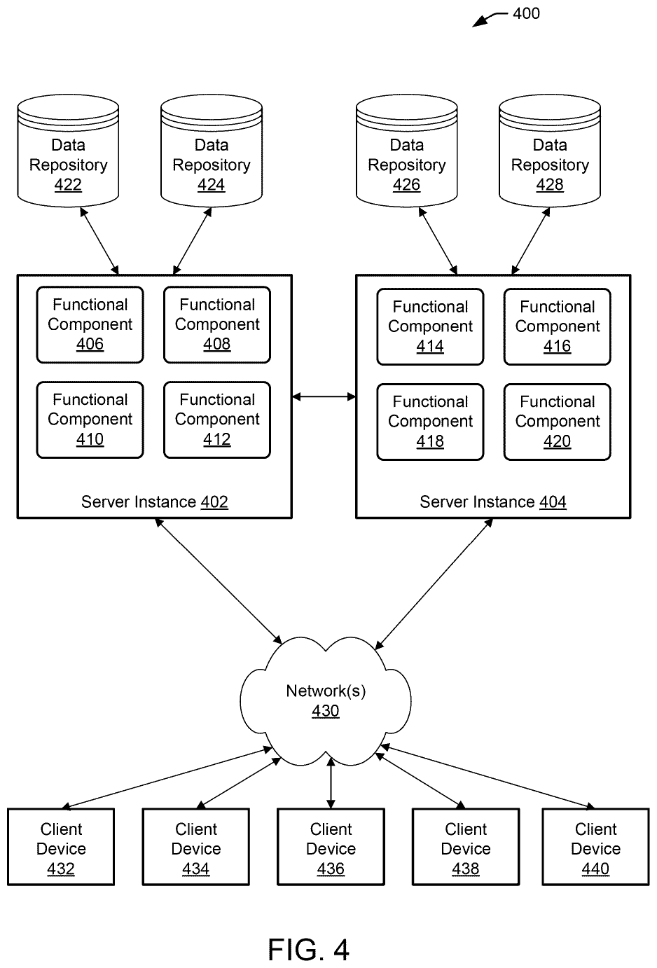

FIG. 4 illustrates a diagram of a distributed system 400 for efficient and robust context pruning for retrieval augmented generation.

As shown, client computing devices 432, 434, 436, 438, and/or 440 are in communication with server instances 402 and/or 404 via one or more communication networks 430. Users may use the client computing devices to access services offered by the server instances 402 and/or 404. The client computing devices may include smart phones or other portable handheld devices, general purpose computers such as personal computers and laptops, workstation computers, personal assistant devices, wearable devices, equipment firmware, gaming systems, etc.

Server instance 402 includes functional components 406, 408, 410, and 412 that provide functionality to support services offered by server instance 402. For example, the functionality may be provided via web pages or applications that may be accessed via client devices 432, 434, 436, 438, and/or 440. The functionality may retrieve data, perform computations on the data, sort, filter, or select the data, and cause display of information on client devices 432, 434, 436, 438, and/or 440. Server instance 402 may interact with data repositories 422 and 424 to store and retrieve data to support services offered.

Server instance 404 includes functional components 414, 416, 418, and 420 that provide functionality to support services offered by server instance 404. For example, the functionality may be provided via web pages or applications that may be accessed via client devices 432, 434, 436, 438, and/or 440. The functionality may retrieve data, perform computations on the data, sort, filter, or select the data, and cause display of information on client devices 432, 434, 436, 438, and/or 440. Server instance 404 may interact with data repositories 426 and 428 to store and retrieve data to support services offered. Server instances 402 and 404 may also communicate with each other to support services offered, utilizing functionality offered by functional components of another server instance to provide a more comprehensive service to client devices 432, 434, 436, 438, and/or 440.

These client and server devices may use various operating systems, such as any of Microsoft Windows®, Apple MacOS®, UNIX® or UNIX-like operating systems, Linux® or Linux-like operating systems, Android®, and Apple iOS®, which provide software access to underlying hardware resources.

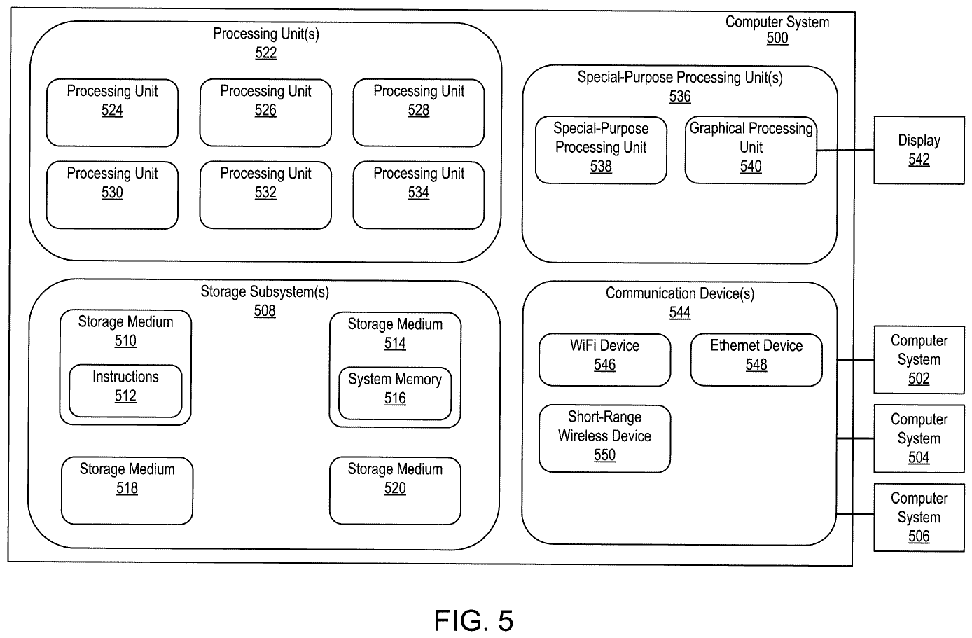

The data repositories 422, 424, 426, and 428 store data, which may include instructions, stored objects, server instance activity logs, and other data. Server instances 402 and 404 may each be computer systems as described in FIG. 5 or may be hosted virtually on computer systems that also provide other functionality or host other server instances using shared and non-shared resources of the host computer system.

FIG. 5 illustrates an example computer system 500 that may be used to efficiently and robustly prune context for retrieval augmented generation.

As shown, the computer system 500 includes storage subsystem(s) 508, which may include storage media 510, 514, 518, and 520. Storage medium 510 may include stored instructions, for example, for carrying out application or server functionality. Storage medium 514 may include system memory 516 for managing objects that are being manipulated by computer system 500 during execution of an application or provision of a service. Storage sub-system(s) 508 may include one or more non-transitory computer-readable storage media, which may be in the form of removable and tangible computer program products or non-removable and tangible storage hardware, storing instructions which, when executed on the one or more data processors such as processing unit(s) 522, special-purpose processing unit(s) 536, or computer systems 502, 504, or 506, cause the one or more data processors to perform part or all of one or more methods disclosed herein. The term computer-readable medium, as used herein, does not encompass transitory electrical or electromagnetic signals propagating through a medium (such as on a carrier wave); the term computer-readable medium may therefore be considered tangible and non-transitory. The non-transitory computer-readable media may be volatile media that is available when computer system 500 or the media itself is powered, or non-volatile storage media such that the information contained thereon may survive a power-down event for the computer-system or for the media itself.

Processing unit(s) 522 may include processing units 524, 526, 528, 530, 532, and 534. The processing unit(s) may operate separately or otherwise independently, or in coordination together to accomplish complex tasks using parallel processing of sub-operations to be carried out as part of the complex tasks. Processing unit(s) may store information in storage subsystem(s) 508 as tasks are carried out.

Special-purpose processing unit(s) 536 may include special-purpose processing unit 538, such as a processing unit optimized for performing vector-based calculations to support machine learning operations. Special-purpose processing unit(s) 536 also include graphical processing unit 540, which communicates with processing unit(s) 522 and storage subsystem(s) 508 to display information on display 542.

Communication device(s) 544 may include WiFi device 546, Ethernet device 548, and/or short-range wireless device 550. WiFi device 546 and Ethernet device 548 may be part of a network device for communicating using a suite of communication protocols such as Transmission Control Protocol/Internet Protocol (TCP/IP) to communicate with other devices such as computer systems 502, 504, and 506 over the Internet. Short-range wireless device may also communicate with computer systems 502, 504, and 506 using short-range protocols such as BlueTooth®, Z-Wave®, and Zigbee®.

Computer system 500 may also include input devices such as mice, keyboards, touchscreens, touchpads, buttons, joysticks, and output devices such as display 542 and a speaker.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by a skilled technician or programmer. The computer programs include processor-executable instructions that are stored on at least one non-transitory, tangible computer-readable medium. The computer programs may also include or rely on stored data.

The computer programs may include: (i) descriptive or hierarchical text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently (i.e., operations occurring within the same timeframe, potentially overlapping but not necessarily precisely at the same moment; e.g., a system adapted to execute multiple work units (e.g., threads) concurrently by using multiple physical processors, allowing for parallel execution of multiple processes where each processor may execute one or more threads, or by using a single (multi-threaded) process that divides work units into multiple smaller threads that can be executed concurrently within the single process). In addition, the order of the operations may be rearranged. The terms “first,” “second,” “third,” “fourth,” “fifth,” and “sixth” are naming conventions used so different items may be referred to separately and are not intended to convey an order or priority unless such order or priority is conveyed with other language. For example, a “first clause” is not necessarily the first-occurring clause of a passage unless stated otherwise, and the name “first clause” may be used to distinguish from a “second clause,” which is not necessarily the second-occurring clause of the passage, and a “third clause,” which is not necessarily the third-occurring clause of the passage. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
accessing a query;
determining, from a corpus of content comprising a plurality of clauses from a plurality of passages, one or more passages that are potentially relevant to the query, wherein the one or more passages comprise a subset of three or more clauses;
encoding the subset of three or more clauses to determine a clause-to-query relevance score for each clause, wherein a particular clause-to-query relevance score of at least one clause of the subset of three or more clauses is dependent on content of at least one other clause of the subset of three or more clauses;
based at least in part on one or more clause-to-query relevance scores of one or more clauses of the subset of three or more clauses, removing the one or more clauses from the subset of three or more clauses to generate a revised subset of clauses;
generating a prompt to a natural language processor, the prompt comprising:
instructions based at least in part on the query, and
at least part of the revised subset of clauses as context for generating a response by the natural language processor;
prompting the natural language processor with the prompt; and
accessing and storing a result generated based at least in part on the natural language processor executing the prompt.

2. The computer-implemented method of claim 1, wherein encoding the subset of three or more clauses comprises, for each clause of the subset of three or more clauses:
determining a token-to-query relevance score of each token in the clause based at least in part on a token-to-query similarity between a token embedding of the token and a query embedding of the query;
determining the clause-to-query relevance score of the clause based at least in part on the token-to-query relevance score of each token in the clause;
wherein the token embedding for at least one token of the at least one clause is based at least in part on content of the at least one clause and the at least one other clause of the subset of three or more clauses.

3. The computer-implemented method of claim 1, wherein determining,
from the corpus of content, the one or more passages comprises determining a passage-to-query similarity between vector embeddings of the plurality of passages and a vector embedding of the query.

4. The computer-implemented method of claim 1, further comprising:
splitting a plurality of documents into a plurality of passages comprising consecutive sentences; and
training a model to identify which passages of the plurality of passages are most relevant to respective queries to generate a trained passage selection model;
wherein determining the one or more passages uses the trained passage selection model.

5. The computer-implemented method of claim 1, further comprising:
training a model to identify which clauses of subsets of clauses are most relevant to respective queries to generate a trained clause selection model at least in part by:
prompting a large language model with a plurality of prompts that request selection of most relevant clauses; and
assigning weights to features of clauses based at least in part on results from prompting with the plurality of prompts;
wherein encoding the subset of three or more clauses uses the trained clause selection model.

6. The computer-implemented method of claim 5, wherein the trained clause selection model is trained to select subsets of clauses that are most relevant to the respective queries relative to a total amount of information represented among each subset of the subsets of clauses for a particular passage.

7. The computer-implemented method of claim 1, wherein determining the one or more passages is based at least in part on one or more passage-to-query similarity scores determined using an initial passage selection model, the computer-implemented method further comprising:
adjusting the one or more passage-to-query similarity scores using another passage selection model;
determining the one or more clause-to-query relevance scores for the one or more clauses using a clause selection model;
wherein the clause selection model is trained to prune clauses separately from the other passage selection model that is trained to determine most relevant passages, and wherein the other passage selection model incorporates more features than the initial passage selection model.

8. The computer-implemented method of claim 1, wherein determining the one or more passages is based at least in part on one or more passage-to-query similarity scores, the computer-implemented method further comprising determining the one or more clause-to-query relevance scores for the one or more clauses and adjusting the one or more passage-to-query similarity scores using a combined machine learning model;
wherein removing the one or more clauses from the subset of three or more clauses to generate the revised subset of clauses is based at least in part on the one or more clause-to-query relevance scores.

9. The computer-implemented method of claim 1, wherein determining, from the corpus of content, the one or more passages results in an initial ranking of two or more passages, the computer-implemented method further comprising concurrently re-ranking the two or more passages and selecting the one or more clauses for removal; wherein the natural language processor comprises a large language model.

10. The computer-implemented method of claim 9, further comprising selecting the one or more clauses for removal based on which subsets of clauses are most relevant to the query relative to a total amount of information represented among each subset of the subsets of clauses for a particular passage.

11. The computer-implemented method of claim 2, further comprising:
causing display of an option to adjust a threshold for selecting clauses for removal,
receiving a selection of the option to adjust the threshold, resulting in an adjusted threshold;
wherein the one or more clauses are selected for removal based at least in part on the adjusted threshold.

12. The computer-implemented method of claim 1, wherein a first clause of the subset of three or more clauses is a title of a first passage of the plurality of passages, a second clause of the subset of three or more clauses is in a body of the first passage of the plurality of passages, and a third clause of the subset of three or more clauses is also in the body of the first passage of the plurality of passages; wherein the third clause is removed from the subset of three or more clauses to generate the revised subset of clauses.

13. A system comprising:
one or more processors;
one or more non-transitory computer-readable media storing instructions, which, when executed by the system, cause the system to perform a set of actions comprising:
accessing a query;
determining, from a corpus of content comprising a plurality of clauses from a plurality of passages, one or more passages that are potentially relevant to the query, wherein the one or more passages comprise a subset of three or more clauses;
encoding the subset of three or more clauses to determine a clause-to-query relevance score for each clause, wherein a particular clause-to-query relevance score of at least one clause of the subset of three or more clauses is dependent on content of at least one other clause of the subset of three or more clauses;
based at least in part on one or more clause-to-query relevance scores of one or more clauses of the subset of three or more clauses, removing the one or more clauses from the subset of three or more clauses to generate a revised subset of clauses;
generating a prompt to a natural language processor, the prompt comprising:
instructions based at least in part on the query, and
at least part of the revised subset of clauses as context for generating a response by the natural language processor;
prompting the natural language processor with the prompt; and
accessing and storing a result generated based at least in part on the natural language processor executing the prompt.

14. The system of claim 13, wherein encoding the subset of three or more clauses comprises, for each clause of the subset of three or more clauses:
determining a token-to-query relevance score of each token in the clause based at least in part on a token-to-query similarity between a token embedding of the token and a query embedding of the query;
determining the clause-to-query relevance score of the clause based at least in part on the token-to-query relevance score of each token in the clause;
wherein the token embedding for at least one token of the at least one clause is based at least in part on content of the at least one clause and the at least one other clause of the subset of three or more clauses.

15. The system of claim 13, wherein the set of actions further comprises:
training a model to identify which clauses of subsets of clauses are most relevant to respective queries to generate a trained clause selection model at least in part by:
prompting a large language model with a plurality of prompts that request selection of most relevant clauses; and
assigning weights to features of clauses based at least in part on results from prompting with the plurality of prompts;
wherein encoding the subset of three or more clauses uses the trained clause selection model.

16. The system of claim 13, wherein determining the one or more passages is based at least in part on one or more passage-to-query similarity scores determined using an initial passage selection model, wherein the set of actions further comprises:
adjusting the one or more passage-to-query similarity scores using another passage selection model;
determining the one or more clause-to-query relevance scores for the one or more clauses using a clause selection model;
wherein the clause selection model is trained to prune clauses separately from the other passage selection model that is trained to determine most relevant passages, and wherein the other passage selection model incorporates more features than the initial passage selection model.

17. The system of claim 13, wherein determining the one or more passages is based at least in part on one or more passage-to-query similarity scores, wherein the set of actions further comprises determining the one or more clause-to-query relevance scores for the one or more clauses and adjusting the one or more passage-to-query similarity scores using a combined machine learning model;
wherein removing the one or more clauses from the subset of three or more clauses to generate the revised subset of clauses is based at least in part on the one or more clause-to-query relevance scores.

18. The system of claim 13, wherein determining, from the corpus of content, the one or more passages results in an initial ranking of two or more passages, wherein the set of actions further comprises using a single trained model to concurrently re-rank the two or more passages and select the one or more clauses for removal; wherein the natural language processor comprises a large language model.

19. The system of claim 13, wherein the set of actions further comprises:
causing display of an option to adjust a threshold for selecting clauses for removal,
receiving a selection of the option to adjust the threshold, resulting in an adjusted threshold;
wherein the one or more clauses are selected for removal based at least in part on the adjusted threshold.

20. One or more non-transitory computer-readable media storing instructions which, when executed, cause performance of a set of actions comprising:
accessing a query;
determining, from a corpus of content comprising a plurality of clauses from a plurality of passages, one or more passages that are potentially relevant to the query, wherein the one or more passages comprise a subset of three or more clauses;
encoding the subset of three or more clauses to determine a clause-to-query relevance score for each clause, wherein a particular clause-to-query relevance score of at least one clause of the subset of three or more clauses is dependent on content of at least one other clause of the subset of three or more clauses;
based at least in part on one or more clause-to-query relevance scores of one or more clauses of the subset of three or more clauses, removing the one or more clauses from the subset of three or more clauses to generate a revised subset of clauses;
generating a prompt to a natural language processor, the prompt comprising:
instructions based at least in part on the query, and
at least part of the revised subset of clauses as context for generating a response by the natural language processor;
prompting the natural language processor with the prompt; and
accessing and storing a result generated based at least in part on the natural language processor executing the prompt.

21. The one or more non-transitory computer-readable media of claim 20, wherein encoding the subset of three or more clauses comprises, for each clause of the subset of three or more clauses:
determining a token-to-query relevance score of each token in the clause based at least in part on a token-to-query similarity between a token embedding of the token and a query embedding of the query;
determining the clause-to-query relevance score of the clause based at least in part on the token-to-query relevance score of each token in the clause;
wherein the token embedding for at least one token of the at least one clause is based at least in part on content of the at least one clause and the at least one other clause of the subset of three or more clauses.

22. The one or more non-transitory computer-readable media of claim 20, wherein the set of actions further comprises:
training a model to identify which clauses of subsets of clauses are most relevant to respective queries to generate a trained clause selection model at least in part by:
prompting a large language model with a plurality of prompts that request selection of most relevant clauses; and
assigning weights to features of clauses based at least in part on results from prompting with the plurality of prompts;
wherein encoding the subset of three or more clauses uses the trained clause selection model.

23. The one or more non-transitory computer-readable media of claim 20, wherein determining the one or more passages is based at least in part on one or more passage-to-query similarity scores determined using an initial passage selection model, wherein the set of actions further comprises:
adjusting the one or more passage-to-query similarity scores using another passage selection model;
determining the one or more clause-to-query relevance scores for the one or more clauses using a clause selection model;
wherein the clause selection model is trained to prune clauses separately from the other passage selection model that is trained to determine most relevant passages, and wherein the other passage selection model incorporates more features than the initial passage selection model.

24. The one or more non-transitory computer-readable media of claim 20, wherein determining the one or more passages is based at least in part on one or more passage-to-query similarity scores, wherein the set of actions further comprises determining the one or more clause-to-query relevance scores for the one or more clauses and adjusting the one or more passage-to-query similarity scores using a combined machine learning model;
wherein removing the one or more clauses from the subset of three or more clauses to generate the revised subset of clauses is based at least in part on the one or more clause-to-query relevance scores.

25. The one or more non-transitory computer-readable media of claim 20, wherein determining, from the corpus of content, the one or more passages results in an initial ranking of two or more passages, wherein the set of actions further comprises using a single trained model to concurrently re-rank the two or more passages and select the one or more clauses for removal; wherein the natural language processor comprises a large language model.

26. ne or more non-transitory computer-readable media of claim 20, wherein the set of actions further comprises:
causing display of an option to adjust a threshold for selecting clauses for removal,
receiving a selection of the option to adjust the threshold, resulting in an adjusted threshold;
wherein the one or more clauses are selected for removal based at least in part on the adjusted threshold.

27. A computer-implemented method for optimizing clauses retrieved from a data store to determine an answer to a query received from a user, the computer-implemented method comprising:
retrieving from the data store a first set of clauses that are ranked by relevance to answering the query;
processing the query and the first set of clauses to produce a subset of clauses with a context pruning subsystem that concurrently:
prunes the first set of clauses to produce a subset of the first set of clauses, and
generates a re-rank score for at least one passage comprising the subset of the first set of clauses by relevance to answering the query;
prompting a natural language processor to provide the answer to the query, wherein the prompting uses the query and the subset of clauses as included context for providing the answer to the query;
wherein the context pruning subsystem is trained for pruning at least some clauses using a cross-encoder that encodes queries and candidate clauses of a training set and generates output comprising:
remaining subsets of the candidate clauses for the queries of the training set, wherein the remaining subsets exclude the at least some clauses that were pruned; and
rankings of the remaining subsets of the candidate clauses.

28. The computer-implemented method of claim 27, further comprising:
receiving the query from a user interface; and
outputting the answer to the user interface;
wherein the at lease some clauses are pruned using a binary mask;
wherein the rankings of the remaining subsets of the candidate clauses are generated using re-rank scores; and
wherein the context pruning subsystem is stored in a memory and the natural language processor is a large language model.

29. The computer-implemented method of claim 28, wherein the user interface comprises executable logic for receiving input via an interactive input device, and wherein the interactive input device is a display, a keyboard, a mouse, a microphone, a speaker, or any combination thereof.
